(19) United States
(12) Patent Application Publication
(10) Pub. No.: US 2021/0329550 A1
(43) Pub. Date: Oct. 21, 2021

(54) Flexible User Equipment Grouping for Wake-Up Signals

(71) Applicant: Telefonaktiebolaget LM Ericsson (publ), Stockholm (SE)

(72) Inventors: Magnus Åström, Lund (SE); Johan Bergman, Stockholm (SE); Andreas Höglund, Solna (SE)

(21) Appl. No.: 17/273,409

(22) PCT Filed: Sep. 27, 2019
(86) PCT No.: PCT/EP2019/076168

§ 371 Date: Mar. 4, 2021

Related U.S. Application Data
(60) Provisional application No. 62/737,553, filed on Sep. 27, 2018.
(60) Provisional application No. 62/738,751, filed on Sep. 28, 2018.

(51) Int. Cl. H04W 52/02; H04W 68/02

(52) U.S. Cl. CPC H04W 52/0219; H04W 68/02; H04W 52/0235

(57) ABSTRACT

Exemplary embodiments include methods for transmitting a wake-up signal (WUS) to one or more user equipment (UEs) in a cell of a radio access network. Exemplary embodiments can include receiving a paging message identifying at least a portion of the UEs. Exemplary embodiments can also include selecting a WUS code associated with the identified UEs, wherein the WUS code is selected from a first plurality of available WUS codes that are mapped to a second plurality of UE groups. Certain exemplary embodiments can include determining the mapping between the first plurality and the second plurality, and transmitting the determined mapping to the one or more UEs. Exemplary embodiments can also include transmitting the WUS based on the selected WUS code. Other exemplary embodiments include methods for receiving a WUS transmitted by a RAN node, as well as network nodes and UEs configured to perform operations corresponding to exemplary methods.

### TECHNICAL FIELD OF THE DISCLOSURE

The present invention generally relates to wireless communication networks, and particularly relates to improvements in operation of very-low-power devices in a wireless communication network.

### BACKGROUND INFORMATION

Long Term Evolution (LTE) is an umbrella term for so-called fourth-generation (4G) radio access technologies developed within the Third-Generation Partnership Project (3GPP) and initially standardized in Release 8 (Rel-8) and Release 9 (Rel-9), also known as Evolved UTRAN (E-UTRAN). LTE is targeted at various licensed frequency bands and is accompanied by improvements to non-radio aspects commonly referred to as System Architecture Evolution (SAE), which includes Evolved Packet Core (EPC) network. LTE continues to evolve through subsequent releases. One of the features of Release 11 is an enhanced Physical Downlink Control Channel (ePDCCH), which has the goals of increasing capacity and improving spatial reuse of control channel resources, improving inter-cell interference coordination (ICIC), and supporting antenna beamforming and/or transmit diversity for control channel.

An overall exemplary architecture of a network comprising LTE and SAE is shown in FIG. 1. E-UTRAN 100 comprises one or more evolved Node B's (eNB), such as eNBs 105, 110, and 115, and one or more user equipment (UE), such as UE 120. As used within the 3GPP standards, “user equipment” or “UE” means any wireless communication device (e.g., smartphone or computing device) capable of communicating with 3GPP-standard-compliant network equipment, including E-UTRAN as well as UTRAN and/or GERAN, as the third- (“3G”) and second-generation (“2G”) 3GPP radio access networks are commonly known.

As specified by 3GPP, E-UTRAN 100 is responsible for all radio-related functions in the network, including radio bearer control, radio admission control, radio mobility control, scheduling, and dynamic allocation of resources to UEs in uplink and downlink, as well as security of the communications with the UE. These functions reside in the eNBs, such as eNBs 105, 110, and 115. The eNBs in the E-UTRAN communicate with each other via the X1 interface, as shown in FIG. 1. The eNBs also are responsible for the E-UTRAN interface to the EPC, specifically the S1 interface to the Mobility Management Entity (MME) and the Serving Gateway (SGW), shown collectively as MME/S-GWs 134 and 138 in FIG. 1. Generally speaking, the MME/S-GW handles both the overall control of the UE and data flow between the UE and the rest of the EPC. More specifically, the MME processes the signaling protocols between the UE and the EPC, which are known as the Non-Access Stratum (NAS) protocols. The S-GW handles all Internet Procotol (IP) data packets between the UE and the EPC, and serves as the local mobility anchor for the data bearers when the UE moves between eNBs, such as eNBs 105, 110, and 115.

FIG. 2 shows a high-level block diagram of an exemplary LTE architecture in terms of its constituent entities—UE, E-UTRAN, and EPC—and high-level functional division into the Access Stratum (AS) and the Non-Access Stratum (NAS). FIG. 2 also illustrates two particular interface points, namely Uu (UE/E-UTRAN Radio Interface) and S1 (E-UTRAN/EPC interface), each using a specific set of protocols, i.e., Radio Protocols and S1 Protocols. Each of the two protocols can be further segmented into user plane (or “U-plane”) and control plane (or “C-plane”) protocol functionality. On the Uu interface, the U-plane carries user information (e.g., data packets) while the C-plane is carries control information between UE and E-UTRAN.

FIG. 3 illustrates a block diagram of an exemplary C-plane protocol stack on the Uu interface comprising Physical (PHY), Medium Access Control (MAC), Radio Link Control (RLC), Packet Data Convergence Protocol (PDCP), and Radio Resource Control (RRC) layers. The PHY layer is concerned with how and what characteristics are used to transfer data over transport channels on the LTE radio interface. The MAC layer provides data transfer services on logical channels, maps logical channels to PHY transport channels, and reallocates PHY resources to support these services. The RLC layer provides error detection and/or correction, concatenation, segmentation, and reassembly, reordering of data transferred to or from the upper layers. The PHY, MAC, and RLC layers perform identical functions for both the U-plane and the C-plane. The PDCP layer provides ciphering/deciphering and integrity protection for both U-plane and C-plane, as well as other functions for the U-plane such as header compression.

FIG. 4 shows a block diagram ofan exemplary LTE radio interface protocol architecture from the perspective of the PHY. The interfaces between the various layers are provided by Service Access Points (SAPs), indicated by the ovals in FIG. 4. The PHY layer interfaces with the MAC and RRC protocol layers described above. The MAC provides different logical channels to the RLC protocol layer (also described above), characterized by the type of information transferred, whereas the PHY provides a transport channel to the MAC, characterized by how the information is transferred over the radio interface. In providing this transport service, the PHY performs various functions including error detection and correction; rate-matching and mapping of the coded transport channel onto physical channels; power weighting, modulation; and demodulation of physical channels; transmit diversity, beamforming multiple input multiple output (MIMO) antenna processing; and providing radio measurements to higher layers, such as RRC.

Generally speaking, a physical channel corresponds a set of resource elements carrying information that originates from higher layers. Downlink (i.e., eNB to UE) physical channels provided by the LTE PHY include Physical Downlink Shared Channel (PDSCH), Physical Multicast Channel (PMCH), Physical Downlink Control Channel (PDCCH), Relay Physical Downlink Control Channel (R-PDCCH), Physical Broadcast Channel (PBCH), Physical Control Format Indicator Channel (PCFICH), and Physical Hybrid ARQ Indicator Channel (PHICH). In addition, the LTE PHY downlink includes various reference signals, synchronization signals, and discovery signals.

PDSCH is the main physical channel used for unicast downlink data transmission, but also for transmission of RAR (random access response), certain system information blocks, and paging information. PBCH carries the basic system information, required by the UE to access the network. PDCCH is used for transmitting downlink control information (DCI), mainly scheduling decisions, required for reception of PDSCH, and for uplink scheduling grants enabling transmission on PUSCH.

Uplink (i.e., UE to eNB) physical channels provided by the LTE PHY include Physical Uplink Shared Channel (PUSCH), Physical Uplink Control Channel (PUCCH), and Physical Random Access Channel (PRACH). In addition, the LTE PHY uplink includes various reference signals including demodulation reference signals (DM-RS), which are transmitted to aid the eNB in the reception of an associated PUCCH or PUSCH; and sounding reference signals (SRS), which are not associated with any uplink channel.

PUSCH is the uplink counterpart to the PDSCH. PUCCH is used by UEs to transmit uplink control information, including HARQ acknowledgements, channel state information reports, etc. PRACH is used for random access preamble transmission.

The multiple access scheme for the LTE PHY is based on Orthogonal Frequency Division Multiplexing (OFDM) with a cyclic prefix (CP) in the downlink, and on Single-Carrier Frequency Division Multiple Access (SC-FDMA) with a cyclic prefix in the uplink. To support transmission in paired and unpaired spectrum, the LTE PHY supports both Frequency Division Duplexing (FDD) (including both full- and half-duplex operation) and Time Division Duplexing (TDD). FIG. 5 shows an exemplary radio frame structure (“type 1”) used for LTE FDD downlink (DL) operation. The DL radio frame has a fixed duration of 10 ms and consists of 20 slots, labeled 0 through 19, each with a fixed duration of 0.5 ms. A 1-ms subframe comprises two consecutive slots where subframe i consists of slots 2i and 2i+1. Each exemplary FDD DL slot consists of N^{DL}_{symb} OFDM symbols, each of which is comprised of N_{sc} OFDM subcarriers. Exemplary values of N^{DL}_{symb} can be 7 (with a normal CP) or 6 (with an extended-length CP) for subcarrier spacing (SCS) of 15 kHz. The value of N_{sc} is configurable based upon the available channel bandwidth. Since persons of ordinary skill in the art are familiar with the principles of OFDM, further details are omitted in this description.

As shown in FIG. 5, a combination of a particular subcarrier in a particular symbol is known as a resource element (RE). Each RE is used to transmit a particular number of bits, depending on the type of modulation and/or bit-mapping constellation used for that RE. For example, some REs may carry two bits using QPSK modulation, while other REs may carry four or six bits using 16- or 64-QAM, respectively. The radio resources of the LTE PHY are also defined in terms of physical resource blocks (PRBs). A PRB spans N^{RB}_{sc} sub-carriers over the duration of a slot (i.e., N^{DL}_{symb} symbols), where N^{RB}_{sc} is typically either 12 (with a 15-kHz sub-carrier bandwidth) or 24 (7.5-kHz bandwidth). A PRB spanning the same N^{RB}_{sc} subcarriers during an entire subframe (i.e., 2N^{DL}_{symb} symbols) is known as a PRB pair. Accordingly, the resources available in a subframe of the LTE PHY DL comprise N^{DL}_{RB} PRB pairs, each of which comprises 2N^{DL}_{symb}·N^{RB}_{sc} REs. For a normal CP and 15-KHz SCS, a PRB pair comprises 168 REs.

One exemplary characteristic of PRBs is that consecutively numbered PRBs (e.g., PRBᵢ and PRBᵢ₊₁) comprise consecutive blocks of subcarriers. For example, with a normal CP and 15-KHz sub-carrier bandwidth, PRB₀ comprises sub-carrier 0 through 11 while PRB₁ comprises sub-carriers 12 through 23. The LTE PHY resource also can be defined in terms of virtual resource blocks (VRBs), which are the same size as PRBs but may be of either a localized or a distributed type. Localized VRBs can be mapped directly to PRBs such that VRB n_{yR} corresponds to PRB n_{pRB}=n_{VRB}. On the other hand, distributed VRBs may be mapped to non-consecutive PRBs according to various rules, as described in 3GPP Technical Specification (TS) 36.213 or otherwise known to persons of ordinary skill in the art. However, the term “PRB” shall be used in this disclosure to refer to both physical and virtual resource blocks. Moreover, the term “PRB” will be used henceforth to refer to a resource block for the duration of a subframe, i.e., a PRB pair, unless otherwise specified.

FIG. 6 shows an exemplary LTE FDD uplink (UL) radio frame configured in a similar manner as the exemplary FDD DL radio frame shown in FIG. 5. Using terminology consistent with the above DL description, each UL slot consists of N^{UL}_{symb} OFDM symbols, each of which is comprised of N_{sc} OFDM subcarriers.

As discussed above, the LTE PHY maps the various DL and UL physical channels to the resources shown in FIGS. 5 and 6, respectively. For example, the PHICH carries HARQ feedback (e.g., ACK/NAK) for UL transmissions by the UEs. Similarly, PDCCH carries scheduling assignments, channel quality feedback (e.g., CSI) for the UL channel, and other control information. Likewise, a PUCCH carries uplink control information such as scheduling requests, CSI for the downlink channel, HARQ feedback for eNB DL transmissions, and other control information. Both PDCCH and PUCCH can be transmitted on aggregations of one or several consecutive control channel elements (CCEs), and a CCE is mapped to the physical resource based on resource element groups (REGs), each of which is comprised of a plurality ofREs. For example, a CCE can comprise nine (9) REGs, each of which can comprise four (4) REs.

In LTE, DL transmissions are dynamically scheduled, i.e., in each subframe the base station transmits control information indicating the terminal to which data is transmitted and upon which resource blocks the data is transmitted, in the current downlink subframe. This control signaling is typically transmitted in the first n OFDM symbols in each subframe and the number n (=1, 2, 3 or 4) is known as the Control Format Indicator (CFI) indicated by the PCFICH transmitted in the first symbol of the control region.

While LTE was primarily designed for user-to-user communications, 5G (also referred to as “NR”) cellular networks are envisioned to support both high single-user data rates (e.g., 1 Gb/s) and large-scale, machine-to-machine communication involving short, bursty transmissions from many different devices that share the frequency bandwidth. The 5G radio standards (also referred to as “New Radio” or “NR”) are currently targeting a wide range of data services including eMBB (enhanced Mobile Broad Band), URLLC (Ultra-Reliable Low Latency Communication), and Machine-Type Communications (MTC). These services can have different requirements and objectives. For example, URLLC is intended to provide a data service with extremely strict error and latency requirements, e.g., error probabilities as low as 10⁻⁵ or lower and 1 ms end-to-end latency or lower. For eMBB, the requirements on latency and error probability can be less stringent whereas the required supported peak rate and/or spectral efficiency can be higher. In contrast, URLLC requires low latency and high reliability but with less strict data rate requirements.

One of the solutions for low latency data transmission is shorter transmission time intervals. For NR, in addition to transmission in a slot (such as for LTE, discussed above), a mini-slot transmission is also allowed to reduce latency. A mini-slot may consist of any number of 1 to 14 OFDM symbols. It should be noted that the concepts of slot and mini-slot are not specific to a specific service meaning that a mini-slot may be used for either eMBB, URLLC, or other services.

Recently, there has been a significant amount of 3GPP standardization activity toward specifying LTE enhancements to cover Machine-to-Machine (M2M) and/or Internet of Things (IoT) related use cases. 3GPP Releases 13 (Rel-13) and 14 (Rel-14) include enhancements to support Machine-Type Communications (MTC) with new UE categories (e.g., Cat-M1, Cat-M2), supporting reduced bandwidth of six physical resource blocks (PRBs) (or up to 24 PRBs for Cat-M2), and Narrowband IoT (NB-IoT) UEs having a new NB radio interface with corresponding new UE categories (e.g., Cat-NB1 and Cat-NB2). In the following discussion, the term “eMTC” will be used to distinguish MTC-related LTE enhancements introduced in 3GPP Releases 13-15 from NB-IoT-specific features.

Even so, there are many differences between “legacy” LTE and the procedures and channels defined for eMTC and for NB-IoT. These differences include newly defined physical channels, such as a new physical downlink control channels (called MPDCCH in eMTC and NPDCCH in NB-IoT) and a new physical random-access channel for NB-IoT (called NPRACH). These differences also include coverage level enhancements. By applying repetitions to the transmitted signals and channels, both eMTC and NB-IoT facilitate UE operation at a much lower signal-to-noise-ratio (SNR, also referred to as Es/Iot) compared to LTE. For example, eMTC and NB-IoT have an operating point of Es/Iot≥−15 dB while “legacy” LTE UEs can only operate down to −6 dB Es/IoT—a significant, 9-dB enhancement.

Furthermore, in Rel-15, an important objective is reducing power consumption for UE reception of physical channels. For example, with respect to eMTC, an approved work item (WI) proposes to study and, if found beneficial for idle mode paging and/or connected mode DRX, specify physical signal/channel that can be efficiently decoded or detected prior to decoding the physical downlink control/data channel.

One solution to this objective that is currently specified in 3GPP LTE standards ((i.e., 36-series, such as TS 36.211, 36.213, 36.304 and 36.331) is a “wake up signal” (WUS). A WUS is a short signal transmitted by the eNB that indicates to the UE that it should continue to decode the DL control channel (e.g., full NPDCCH for NB-IoT). If the WUS is absent or is not detected at a time when the UE expects it to occur, then the UE can go back to sleep without decoding the DL control channel. Since the WUS contains only one bit of information, the decoding time for a WUS is considerably shorter than that of the full NPDCCH, which may contain up to 35 bits of information. This reduced decoding requirement improves UE power consumption and leads to longer UE battery life. The WUS is transmitted only when there is paging for the UE, such that WUS for that UE is said to occur in discontinuous transmission (DTX). FIG. 7 illustrates exemplary DTX of WUS and associated paging occasions (POs) over a period of time. In this figure, while blocks indicate potential WUS and associated PO positions, whereas black boxes indicate positions of actual WUS transmission and associated POs on the DL control channel.

In 3GPP Rel-15, the WUS (also referred to as NWUS) sequence w(m) in subframe x=0, 1, . . . , M−1 is defined by:

$$w ( m ) = {θ}_{{n}_{f} , {n}_{s}} ( {m}^{′} ) \cdot {e}^{- \frac{j π un ( n + 1 )}{131}}$$

$$m = 0 , 1 , … , 131$$

$${m}^{′} = m + 132 x$$

$$n = m mod 132$$

$${θ}_{{n}_{f} , {n}_{s}} ( {m}^{′} ) = \{ \begin{matrix}1 , if {c}_{{n}_{f} , {n}_{s}} ( 2 {m}^{′} ) = 0 and {c}_{{n}_{f} , {n}_{s}} ( 2 {m}^{′} + 1 ) = 0 \\ - 1 , if {c}_{{n}_{f} , {n}_{s}} ( 2 {m}^{′} ) = 0 and {c}_{{n}_{f} , {n}_{s}} ( 2 {m}^{′} + 1 ) = 1 \\ j , if {c}_{{n}_{f} , {n}_{s}} ( 2 {m}^{′} ) = 1 and {c}_{{n}_{f} , {n}_{s}} ( 2 {m}^{′} + 1 ) = 0 \\ - j , if {c}_{{n}_{f} , {n}_{s}} ( 2 {m}^{′} ) = 1 and {c}_{{n}_{f} , {n}_{s}} ( 2 {m}^{′} + 1 ) = 1\end{matrix} \\ u = ( {N}_{ID}^{Ncell} mod 126 ) + 3$$

where M is the actual duration of NWUS as defined in 3GPP TS 36.213. The scrambling sequence cₙ_{_{f}}_{,n}_{ₛ}(i), i=0, 1, . . . , 2·132M−1 is given by 36.213 section 7.2 and is initialized at the start of the NWUS according to.

$${c}_{init \_ WUS} = ( {N}_{ID}^{Ncell} + 1 ) ( ( 10 {n}_{f \_ start \_ PO} + ⌊ \frac{{n}_{s \_ start \_ PO}}{2} ⌋ ) mod 2048 + 1 ) {2}^{9} + {N}_{ID}^{Ncell}$$

where n_{f_START_PO} is the first frame of the first PO to which the NWUS is associated, and n_{s_start_PO} is the first slot of the first PO to which the NWUS is associated. Furthermore, the NWUS sequence w(m) is mapped to resource elements (REs) (k,l) in sequence, starting with w(0) in increasing order of first the index k=0, 1, . . . , N_{sc}^{RB}−1, over the 12 assigned subcarriers and then the index l=3, 4, . . . , 2N_{symb}^{DL}−1 in each subframe in which NWUS is transmitted.

As indicated by the above equations, the Rel-15 WUS sequence is dependent on the time instant of the PO to which it is associated and the eNB cell ID (N_{ID}^{Ncell}). As such, is not possible to further distinguish individual UE(s) being paged in a single PO, from all UEs associated with that PO and its associated WUS. In other words, the Rel-15 WUS was designed such that all UEs belongs to the same group. A transmitted WUS associated to a specific PO may wake-up all UEs that are configured to detect paging at that PO. As such, all UEs that are not targeted by the page will wake up unnecessarily. Often only a single UE is paged during a PO, which can lead to increased power consumption for other non-paged UEs that wake up and detect paging in the PO.

Both eMTC and NB-IoT have been developed with varying applications in mind. Contrary to the MBB use cases, eMTC/NB-IoT use cases place widely different requirements on factors such as paging rate, latency, baseband processing power, etc. For example, in one eMTC/NB-IoT use case, a power switch for street lights is paged once daily, whereas in another eMTC/NB-IoT use case, a machine-control device may be paged every second. If these two use cases are supported by the same network, the existing single-grouping configuration is likely to be inadequate for the network to meet the diverse paging requirements of both use cases.

Consequently, for Rel-16, it was agreed that WUS should be further developed to also include UE grouping, such that the number of UEs that are sensitive to the WUS is reduced to a smaller subset of the UEs associated with the corresponding PO. Even so, there remains a need for flexible, adaptive, and/or efficient approaches to determine UE grouping information and configure the affected UEs with such grouping information.

### SUMMARY

Embodiments of the present disclosure provide specific improvements to communication between user equipment (UE) and network nodes in a wireless communication network, such as by facilitating solutions to overcome the exemplary problems described above.

Some exemplary embodiments of the present disclosure include methods and/or procedures for transmitting a wake-up signal (WUS) to one or more user equipment (UEs) in a radio access network (RAN). The exemplary methods and/or procedures can be performed by a network node (e.g., base station, eNB, gNB, etc., or component thereof) in communication with one or more user equipment (UE, e.g., wireless device, IoT device, modem, etc. or component thereof).

In some embodiments, the exemplary methods and/or procedures can include determining a mapping between a first plurality of available WUS codes and a second plurality of UE groups. In some embodiments, the exemplary methods and/or procedures can also include transmitting the determined mapping to the one or more UEs.

The exemplary methods and/or procedures can also include receiving a paging message identifying at least a portion of the UEs in the cell. For example, the network node can receive the paging message from a node (e.g., MME) in an associated core network. In some embodiments, the network node can also receive, for each of the identified UEs, an identifier of an individual UE group to the particular UE is assigned. In some embodiments, the identifiers can be included in the paging message.

The exemplary methods and/or procedures can also include selecting a WUS code associated with the identified UEs, wherein the WUS code is selected from a first plurality of available WUS codes that are mapped to a second plurality of UE groups. In some embodiments, the second plurality of UE groups can include a plurality of individual UE groups. In some embodiments, the second plurality of UE groups includes only individual UE groups. In some embodiments, the second plurality can be equal to the first plurality. In some embodiments, the second plurality of UE groups also includes a common UE group associated with all individual UE groups. In some embodiments, the second plurality of UE groups can include one or more combination UE groups, wherein each combination UE group can be associated with a particular combination of multiple individual UE groups. In some embodiments, selecting the WUS code can be based on the identified individual UE groups associated with the identified UEs.

The exemplary methods and/or procedures can also include transmitting the WUS based on the selected WUS code.

Other exemplary embodiments of the present disclosure include methods and/or procedures for receiving a wake-up signal (WUS) transmitted by a network node in a radio access network (RAN). The exemplary methods and/or procedures can be performed by user equipment (e.g., UE, wireless device, IoT device, modem, etc. or component thereof) in communication with a network node (e.g., base stations, eNBs, gNBs, etc., or components thereof) configured to serve the cell in the RAN.

These exemplary methods and/or procedures can include receiving information comprising a mapping between a first plurality of available WUS codes and a second plurality of UE groups, wherein the second plurality comprises a plurality of individual UE groups and at least one combination UE group associated with multiple individual UE groups. The exemplary methods and/or procedures can also include receiving an assignment to one of the individual UE groups.

The exemplary methods and/or procedures can also include receiving a signal during a period when the first WUS is expected to be transmitted. For example, the signal can be received in time and frequency resources (e.g., subcarriers and symbol) that are associated with WUS transmission by the network node and/or the RAN. The exemplary methods and/or procedures can also include attempting to detect, in the received signal, a WUS corresponding to any of a third plurality of WUS codes, wherein the third plurality comprises a WUS code associated with the assigned individual UE group and one or more WUS codes associated with respective one or more combination UE groups.

In some embodiments, if the WUS corresponding to any of the third plurality of WUS codes is detected, the exemplary method and/or procedure can also include receiving a paging signal during a subsequent paging occasion (PO) at a predefined later time relative to the WUS. In some embodiments, if the WUS corresponding to a particular one of the third plurality of WUS codes is detected, the exemplary methods and/or procedures can also include receiving a physical downlink shared channel (PDSCH) at a predefined later time relative to the WUS or to an intervening paging occasion (PO) associated with the WUS. Receiving the PDSCH in this manner can be done without attempting to receive a paging signal during the PO.

Other exemplary embodiments of the present disclosure include methods and/or procedures for paging one or more user equipment (UE) based on wake-up signals (WUS) transmitted in a radio access network (RAN). These exemplary methods and/or procedures can be performed by a core network node (e.g., MME) in communication with a RAN node (e.g., base station, eNB, gNB, etc., or components thereof) and the one or more UEs (e.g., wireless device, IoT device, modem, etc. or component thereof).

These exemplary methods and/or procedures can include assigning each of the one or more UEs to a respective individual UE group. The exemplary methods and/or procedures can also include determining a mapping between a first plurality of available WUS codes and a second plurality of UE groups, wherein the second plurality comprises a plurality of individual UE groups and at least one combination UE group associated with multiple individual UE groups. The exemplary methods and/or procedures can also include sending the determined mapping and the respective individual UE group assignments to the one or more UEs via the RAN (e.g., via the eNB(s) serving the cell(s) in which the one or more UEs are located). The exemplary methods and/or procedures can also include sending a paging request to a node in the RAN, wherein the paging request identifies at least a portion of the one or more UEs and the respective individual UE group assignments of the identified UEs

Other exemplary embodiments include network nodes (e.g., radio base station(s), eNBs, gNBs, CU/DU, controllers, MMEs, etc. or components thereof) or user equipment (e.g., UE, wireless devices, IoT devices, or components thereof, such as a modem) configured to perform operations corresponding to various ones of the exemplary methods and/or procedures described above. Other exemplary embodiments include non-transitory, computer-readable media storing program instructions that, when executed by at least one processor, configure such network nodes or such UEs to perform operations corresponding to the exemplary methods and/or procedures described above.

Some embodiments advantageously provide methods and apparatuses for configuring a WD-specific WUS WD-group that may advantageously reduce power consumption and/or improve latency performance as compared to existing WUS WD-grouping configurations.

According to one embodiment of this disclosure, a network node includes processing circuitry configured to communicate information indicating a wake-up signal (WUS) WD-group configuration including a WD-specific WUS WD-group configuration; receive at least one paging message for at least one WD; based at least in part on the at least one paging message, determine the at least one WD being paged, at least one WD ofthe at least one WD being paged is configured with the WD-specific WUS WD-group configuration; and communicate a WUS sequence corresponding to a WUS group associated with the at least one WD being paged.

According to an alternative embodiment of this disclosure, a network node includes processing circuitry configured to receive an indication of a WD-specific WUS WD-grouping capability ofthe WD; communicate an indication of a WD-specific WUS WD-group configuration based on the WD-specific WUS WD-grouping capability of the WD; and as a result of data being available for the WD, communicate a paging message for the WD, the paging message identifying the WD-specific WUS WD-group configuration for the WD.

According to another embodiment of this disclosure, a WD includes processing circuitry configured to receive information indicating a wake-up signal (WUS) WD-group configuration; communicate an indication of a WD-specific WUS WD-grouping capability of the WD; receive a WD-specific WUS WD-group configuration based at least in part on the WD-specific WUS WD-grouping capability of the WD; and as a result of at least one paging message, receive a WUS sequence corresponding to the WUS WD-group configuration.

These and other objects, features and advantages of the exemplary embodiments of the present disclosure will become apparent upon reading the following detailed description of the exemplary embodiments of the present disclosure.

### BRIEF DESCRIPTION OF THE DRAWINGS

FIG. 1 is a high-level block diagram of an exemplary architecture of the Long-Term Evolution (LTE) Evolved UTRAN (E-UTRAN) and Evolved Packet Core (EPC) network, as standardized by 3GPP.

FIG. 2 is a high-level block diagram of an exemplary E-UTRAN architecture in terms of its constituent components, protocols, and interfaces.

FIG. 3 is a block diagram of exemplary protocol layers of the control-plane portion of the radio (Uu) interface between a user equipment (UE) and the E-UTRAN.

FIG. 4 is a block diagram of an exemplary LTE radio interface protocol architecture from the perspective of the PHY layer.

FIGS. 5 and 6 are block diagrams, respectively, of exemplary downlink and uplink LTE radio frame structures used for frequency division duplexing (FDD) operation;

FIG. 7 illustrates exemplary discontinuous transmission (DTX) of wake-up signals (WUS) and associated paging occasions (POs) over a period of time.

FIG. 8 shows various exemplary frequency-domain orthogonal cover codes that can be used to distinguish different UE groups, according to various exemplary embodiments of the present disclosure.

FIG. 9 shows a flow diagram of an exemplary method and/or procedure performed by a network node (e.g., base station, gNB, eNB, etc. or component thereof) in a radio access network (RAN), according to various exemplary embodiments of the present disclosure.

FIG. 10 shows a flow diagram of an exemplary method and/or procedure performed by a user equipment (UE, e.g., wireless device, IoT device, modem, etc. or component thereof), according to various exemplary embodiments of the present disclosure.

FIG. 11 shows a flow diagram of an exemplary method and/or procedure performed by a network node (e.g., MME or component thereof) in a core network, according to various exemplary embodiments of the present disclosure FIG. 12 shows a block diagram of an exemplary wireless device or UE according to various exemplary embodiments of the present disclosure.

FIG. 13 shows a block diagram of an exemplary network node according to various exemplary embodiments of the present disclosure.

FIG. 14 shows a block diagram of an exemplary network configured to provide over-the-top (OTT) data services between a host computer and a UE, according to various exemplary embodiments of the present disclosure.

### DETAILED DESCRIPTION

As briefly mentioned above, the present Rel-15 implementation specifies one WUS for each PO and does not allow for further UE grouping, thereby increasing power consumption for non-paged UEs. Due to the wide range of paging and UE power consumption requirements for IoT use cases, there is a need for flexible, adaptive, and/or efficient approaches to determine eMTC/NB-IOT UE grouping information and to configure the affected UEs with such grouping information.

Accordingly, exemplary embodiments ofthe present disclosure provide novel techniques for determining a set of wake-up signal (WUS) codes and a mapping the WUS codes to various groupings of UEs that are allocated to each PO in a cell. Depending on the configuration, a different number of UE groups, sub-groups, and/or group combinations can be mapped to the WUS codes. Accordingly, the UE can be configured to be attentive to, monitor, and/or detect one or more WUS codes, where also the number of codes for monitoring and/or detection can be configured. One or more configurations may be pre-determined (e.g. defined in a standard or specification) and/or pre-configured. Alternately, a network node can transmit a particular configuration to the UEs in a cell that it serves, e.g., in a system information broadcast.

In some embodiments, the set of WUS codes for mapping to UE groups can be predefined and/or preconfigured (e.g., specified in a standard). In some embodiments, the set of WUS codes comprises frequency-domain orthogonal cover codes (OCCs) applied on a per-subcarrier basis to resources (e.g., one or more PRBs) used to transmit the WUS. FIG. 8 shows various exemplary frequency-domain OCCs that can be used to distinguish different UE groups. These frequency-domain OCCs can be applied within a single time-domain symbol (e.g., to a single PRB) of resources used to transmit WU. In other embodiments, the set of WUS codes comprises frequency-domain scrambling codes that can be applied over multiple time-domain symbols of resources used to transmit the WUS. In some embodiments, the set of WUS codes can comprise a combination of frequency-domain orthogonal cover codes and scrambling codes. Various other codes and/or code combinations can also be used in the same or a similar manner.

In some embodiments, a network node (e.g., eNB) can determine a configuration for the mapping of the set of WUS codes onto UE groups based on various factors including, but not limited to, UE properties and/or requirements (e.g., paging rate), WUS false alarm rate, UE capability, or a combination thereof. For example, a high paging rate requirement can increase the likelihood that multiple UEs must be paged in one PO, and thereby increases the benefit of grouping high-paging-rate UEs in the same group. In contrast, lower-paging-rate UEs can be assigned to other UE groups, thereby allowing them to stay in sleep mode for a longer duration. On the other hand, a lower paging rate requirement reduces the likelihood that multiple UEs must be paged in one PO, such that many small groups are preferred.

To address the case where multiple UE groups must be paged in one PO, in some embodiments the set of WUS codes can include a particular code associated with a common UE group. Each UE can be configured to detect this common-group WUS code in addition to the WUS code associated with the group to which the UE is assigned. In other words, the common-group WUS code can wake up all UEs for the next PO.

UE WUS signal detection thresholds are typically set as a compromise between requirements for detecting a WUS signal when it is present and for avoiding false detection when the WUS signal is absent (also referred to as “false alarm”). If a detection threshold is set aggressively, the resulting high WUS false alarm rate and false paging rate can establish a power consumption performance floor, which mitigates the need for many groups. In some embodiments, WUS codes can be assigned to UE group combinations, thereby avoiding, minimizing, and/or reducing the use of a common UE group. Even so, UE capabilities can be limited to detecting less than a particular maximum number of codes in a single WUS instance, which can restrict and/or reduced the number of groups and/or combinations that can be used.

In some embodiments, the network node can derive a paging rate for a particular UE based on values of other parameters that can differentiate the capabilities of various NB-IoT UEs. For example, “Subscription Based UE Differentiation Information” (as defined in 3GPP TS 36.423 and 36.413) can include various UE parameters such as Periodic Time, Battery Indication, Traffic Profile, Stationary Indication, Scheduled Communication Time, etc. These parameters can be used to derive a paging rate for the purposes of assigning a UE to a group, as described above.

In some embodiments, the determination of a group assignment for a particular UE can be performed by a mobility management entity (MME), which can then configure (e.g., signal the assigned group to) the UE via NAS signaling. Subsequently, when the UE is paged, the MME can send the UE's configured WUS group to the UE's serving eNB. For example, this information can be included with the UE's radio paging capabilities in a UE-RadioPagingInfo-NB information element (IE), e.g. as part of the UE radio paging capabilities. An ASN.1 data structure for an enhanced UE-RadioPagingInfo-NB IE is given below (assuming Rel-16), with underline used to indicate the added information:

| | | |
|---|---|---|
| UE-RadioPagingInfo-NB-r13 ::= | SEQUENCE { | |
| ue-Category-NB-r13 | ENUMERATED {nb1} | OPTIONAL, |
| . . . , | | |
| [[ multiCarrierPaging-r14 | ENUMERATED {true} | OPTIONAL |
| ]], | | |
| [[ wusUEgrouping-r16 | INTEGER {1..16} | OPTIONAL |
| ]] | | |
| } | | |

In other embodiments, the group assigned to a UE is instead stored with the UE's context. These embodiments can be useful and/or advantageous when RAN paging is applied and the UE is in INACTIVE state, which can be the case in NR.

In some embodiments, each WUS code can be assigned to a unique UE group. In other embodiments, one WUS code can be assigned to a common UE group and each of the remaining available WUS codes is assigned to particular UE group. These embodiments are illustrated by Table 1 below for the case of 12 available WUS codes and 11 UE groups. In this example, code 0 is assigned to the common UE group and codes 1-11 are assigned to particular individual UE groups. In the table, a “Yes” entry indicates an associating between code (row) and UE group (column); blank entries indicate no association between the particular code and group.

TABLE 1

| | UE-group | | | | | | | | | | |
|---|---|---|---|---|---|---|---|---|---|---|---|
| Code | 0 | 1 | 2 | 3 | 4 | 5 | 6 | 7 | 8 | 9 | 10 |
| 0 | Yes | Yes | Yes | Yes | Yes | Yes | Yes | Yes | Yes | Yes | Yes |
| 1 | Yes | | | | | | | | | | |
| 2 | | Yes | | | | | | | | | |
| 3 | | | Yes | | | | | | | | |
| 4 | | | | Yes | | | | | | | |
| 5 | | | | | Yes | | | | | | |
| 6 | | | | | | Yes | | | | | |
| 7 | | | | | | | Yes | | | | |
| 8 | | | | | | | | Yes | | | |
| 9 | | | | | | | | | Yes | | |
| 10 | | | | | | | | | | Yes | |
| 11 | | | | | | | | | | | Yes |

In other embodiments, the available WUS codes can be assigned to a combination of a common UE group, a plurality of individual UE groups, and one or more UE group combinations. These embodiments are illustrated by Table 2 below for the case of 12 available WUS codes and four UE groups. In this example, code 0 is assigned to the common UE group, codes 1-4 are assigned to particular individual UE groups 0-3, and codes 5-10 are assigned to combinations of UE groups 0-3. Code 11 remains unassigned and/or reserved.

TABLE 2

| | UE-group | | | |
|---|---|---|---|---|
| Code | 0 | 1 | 2 | 3 |
| 0 | Yes | Yes | Yes | Yes |
| 1 | Yes | | | |
| 2 | | Yes | | |
| 3 | | | Yes | |
| 4 | | | | Yes |
| 5 | Yes | Yes | | |
| 6 | Yes | | Yes | |
| 7 | Yes | | | Yes |
| 8 | | Yes | Yes | |
| 9 | | Yes | | Yes |
| 10 | | | Yes | Yes |
| 11 | Undefined | Undefined | Undefined | Undefined |

In some embodiments, a subset of the WUS codes can be associated with particular predefined tasks. For example, a particular WUS code can be used to indicate that an associated UE group should directly read PDSCH at a predefined location in relation to the WUS or the PO, without first needing to decode the paging control channel.

In some embodiments, after determining the mapping between UE groups and WUS codes, the network node (e.g., eNB) can transmit the determined mappings to UEs in the cell served by the network node. For example, the network node can transmit the determined mapping via a broadcast system information block (SIB). As another example, the network node can transmit the determined mapping to individual UEs via RRC signaling. Various combinations of broadcast and RRC transmission can also be used.

In some embodiments, the network node can receive a request to page one or more UEs within the cell (referred to as a “paging request”). For example, the paging request can be received from an MME. In response, the network selects one of the available WUS codes for transmission to the one or more UEs identified by the paging request. Subsequently, the network node transmits a WUS signal based on the selected WUS code.

In some embodiments, if the one or more UEs identified by the paging request are in separate UE groups, the network node can select a WUS code associated with a combination of at least those separate UE groups. In some embodiments, this selected WUS code can be associated with a common UE group. In some embodiments, the network node can select the WUS code based on the false-alarm rates associated with the available WUS codes. For example, the network node can select the WUS code such that a minimum number of the UE groups will be falsely awakened by detecting the selected code.

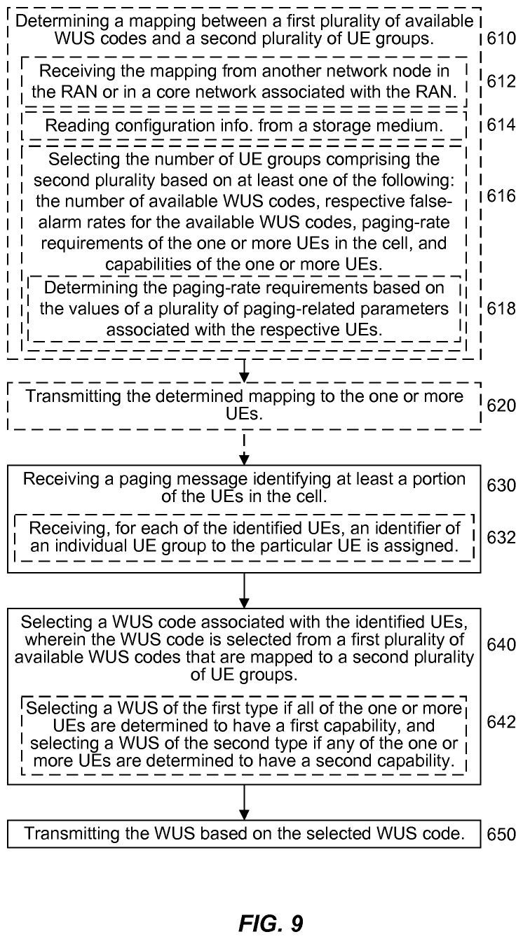

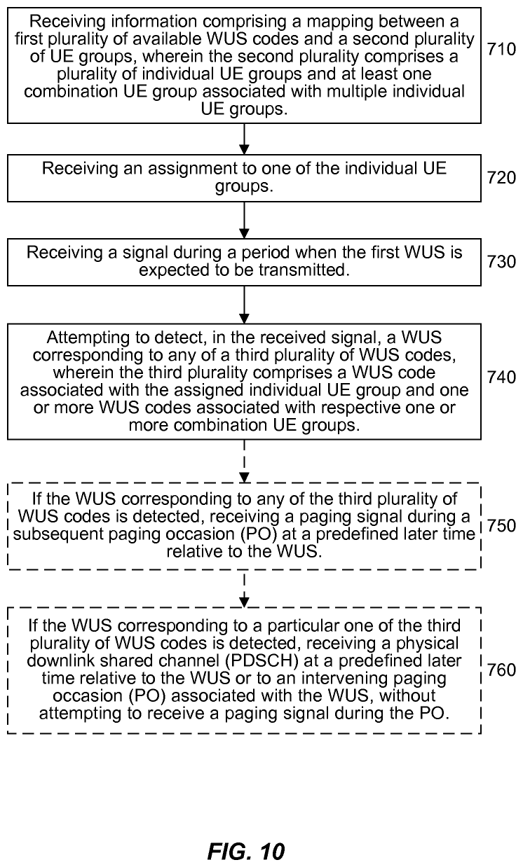

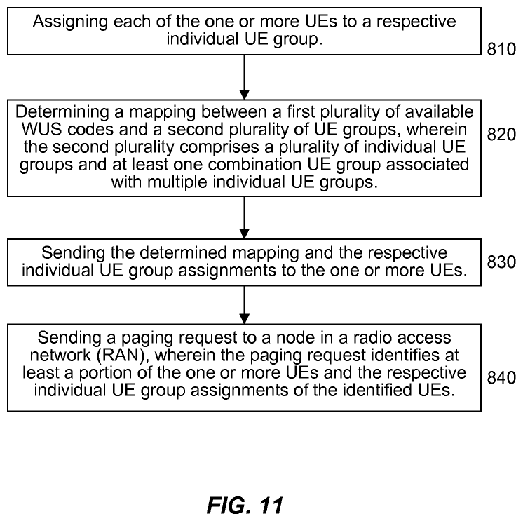

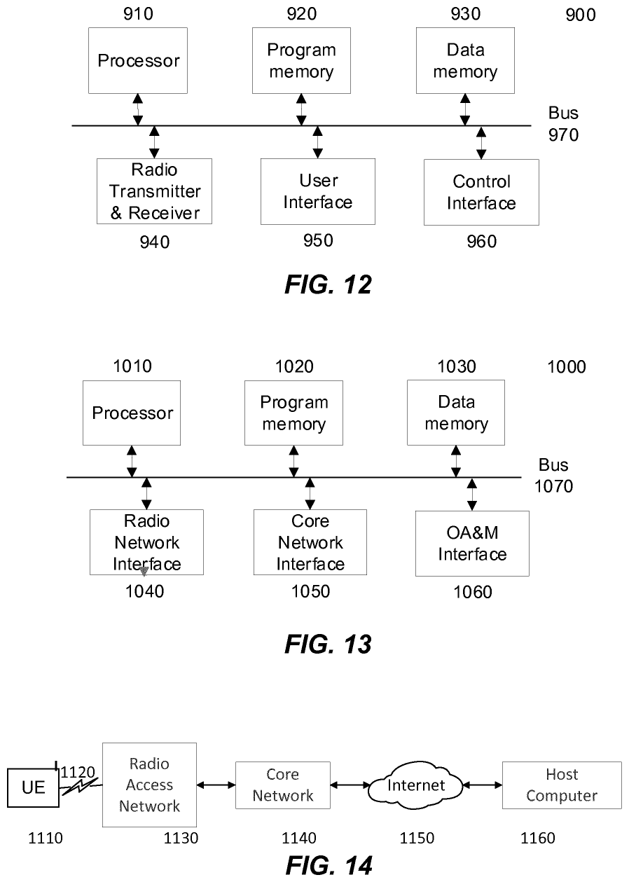

FIG. 9 shows a flow diagram of an exemplary method and/or procedure for transmitting a wake-up signal (WUS) to one or more user equipment (UEs) in a radio access network (RAN). The exemplary method and/or procedure can be performed by a network node (e.g., base station, eNB, gNB, etc., or component thereof) serving a cell in the RAN and in communication with one or more user equipment (e.g., UE, wireless device, IoT device, modem, etc. or component thereof) in the cell. For example, the exemplary method and/or procedure shown in FIG. 9 can be implemented in a network node configured according to FIG. 13 (described below). Furthermore, as explained below, the exemplary method and/or procedure shown in FIG. 9 can be utilized cooperatively with the exemplary method and/or procedures shown in FIG. 10 (described below) and/or FIG. 11 (also described below), to provide various exemplary benefits described herein. Although FIG. 9 shows blocks in a particular order, this order is merely exemplary, and the operations of the exemplary method and/or procedure can be performed in a different order than shown in FIG. 9 and can be combined and/or divided into blocks having different functionality. Optional blocks or operations are shown by dashed lines.

In some embodiments, the exemplary method and/or procedure can include the operations of block 610, where the network node can determine a mapping between a first plurality of available WUS codes and a second plurality of UE groups. In some embodiments, the operations of block 610 can include the operations of sub-block 612, where the network node can receive the mapping from another network node in the RAN or in a core network associated with the RAN. In some embodiments, the operations of block 610 can include the operations of sub-block 614, where the network node can read configuration information (e.g., a file pertaining to the mapping) from a storage medium. For example, the storage medium can be local to or remote from the network node.

In some embodiments, the operations of block 610 can include the operations of sub-block 616, where the network node can select the number of UE groups comprising the second plurality. This selection can be based on at least one of the following: the number of available WUS codes, respective false-alarm rates for the available WUS codes, paging-rate requirements of the one or more UEs in the cell, and capabilities of the one or more UEs. In some embodiments, the operations of sub-block 616 can include the operations of sub-block 618, where the UE can determine the paging-rate requirements of the one or more UEs based on the values of a plurality of paging-related parameters associated with the respective UEs. Examples of such paging-related parameters were discussed above.

In some embodiments, the exemplary method and/or procedure can include the operations of block 620, where the network node can transmit the determined mapping to the one or more UEs. The exemplary method and/or procedure can include the operations of block 630, where the network node can receive a paging message identifying at least a portion of the UEs in the cell. For example, the network node can receive the paging message from a node (e.g., MME) in an associated core network. In some embodiments, the operations of block 630 can also include the operations of sub-block 632, where the network node can receive, for each of the identified UEs, an identifier of an individual UE group to the particular UE is assigned. In some embodiments the network node can receive the group identifiers in the paging message received in block 630.

The exemplary method and/or procedure can include the operations of block 640, where the network node can select a WUS code associated with the identified UEs, wherein the WUS code is selected from a first plurality of available WUS codes that are mapped to a second plurality of UE groups. In some embodiments, the second plurality of UE groups can include a plurality of individual UE groups. In some embodiments, the second plurality of UE groups includes only individual UE groups. In some embodiments, the second plurality can be equal to the first plurality. In some embodiments, the second plurality of UE groups also includes a common UE group associated with all individual UE groups. In some embodiments, the second plurality of UE groups can include one or more combination UE groups, wherein each combination UE group can be associated with a particular combination of multiple individual UE groups.

In some embodiments, selecting the WUS code can be based on the identified individual UE groups (e.g., received in sub-block 632). In some embodiments, at least one of the first plurality of WUS codes is not associated with a paging opportunity (PO). For example, the at least one WUS code can be associated with reception of a PDSCH at a particular time. In some embodiments, the available WUS codes comprise a first plurality of frequency-domain orthogonal cover codes (OCCs) applied over a single time-domain symbol. In some embodiments, wherein the available WUS codes comprise a first plurality of frequency-domain scrambling codes applied over multiple time-domain symbols.

In some embodiments, if the identified UEs are associated with a plurality of individual UE groups the operations of block 640 can also include the operations of sub-block 642, where the network node can select an available WUS code corresponding to a combination UE group that includes a minimum number of individual UE groups other than the one or more individual UE groups. The exemplary method and/or procedure can include the operations of block 650, where the network node can transmit the WUS based on the selected WUS code.

FIG. 10 shows a flow diagram of an exemplary method and/or procedure for receiving a wake-up signal (WUS) transmitted by a network node in a radio access network (RAN). The exemplary method and/or procedure can be performed by a user equipment (e.g., UE, wireless device, IoT device, modem, etc. or component thereof) in communication with a network node (e.g., base station, eNB, gNB, etc., or components thereof) serving a cell in the RAN. For example, the exemplary method and/or procedure shown in FIG. 10 can be implemented, for example, in a UE or device configured according to FIG. 12 (described below). Furthermore, the exemplary method and/or procedure shown in FIG. 10 can be utilized cooperatively with the exemplary method and/or procedure shown in FIG. 9 (described above) and/or FIG. 11 (described below), to provide various exemplary benefits described herein. Although FIG. 10 shows blocks in a particular order, this order is merely exemplary, and the operations ofthe exemplary method and/or procedure can be performed in a different order than shown in FIG. 10 and can be combined and/or divided into blocks having different functionality. Optional blocks or operations are shown by dashed lines.

Exemplary embodiments of the method and/or procedure illustrated in FIG. 10 can include the operations of block 710, where the UE can receive information comprising a mapping between a first plurality of available WUS codes and a second plurality of UE groups, wherein the second plurality comprises a plurality of individual UE groups and at least one combination UE group associated with multiple individual UE groups. In some embodiments, the at least one combination UE group includes a common UE group associated with all individual UE groups. In some embodiments, the at least one combination UE group can include one or more combination UE groups associated with respective subsets of the individual UE groups.

In some embodiments, the available WUS codes comprise a first plurality of frequency-domain orthogonal cover codes (OCCs) applied over a single time-domain symbol. In some embodiments, wherein the available WUS codes comprise a first plurality of frequency-domain scrambling codes applied over multiple time-domain symbols.

The exemplary method and/or procedure can also include operations of block 720, where the UE can receive an assignment to one of the individual UE groups. In some embodiments, the assignment and the mapping (block 710) can be received from an MME. The exemplary method and/or procedure can also include operations of block 730, where the UE can receive a signal during a period when the first WUS is expected to be transmitted. For example, the UE can receive a signal in time and frequency resources (e.g., subcarriers and symbol) that are associated with WUS transmission by the network node and/or the RAN.

The exemplary method and/or procedure can also include operations of block 740, where the UE can attempt to detect, in the received signal, a WUS corresponding to any of a third plurality of WUS codes, wherein the third plurality comprises a WUS code associated with the assigned individual UE group and one or more WUS codes associated with respective one or more combination UE groups.

In some embodiments, if the WUS corresponding to any of the third plurality of WUS codes is detected in block 740, the exemplary method and/or procedure can also include operations of block 750, where the UE can receive a paging signal during a subsequent paging occasion (PO) at a predefined later time relative to the WUS. In some embodiments, if the WUS corresponding to a particular one of the third plurality of WUS codes is detected in block 740, the exemplary method and/or procedure can also include operations of block 750, where the UE can receive a physical downlink shared channel (PDSCH) at a predefined later time relative to the WUS or to an intervening paging occasion (PO) associated with the WUS. Receiving the PDSCH in this manner can be done without attempting to receive a paging signal during the PO.

FIG. 11 shows a flow diagram of an exemplary method and/or procedure for paging one or more user equipment (UE) based on wake-up signals (WUS) transmitted in a radio access network (RAN). The exemplary method and/or procedure can be performed by a core network node (e.g., MME) in communication with a RAN node (e.g., base station, eNB, gNB, etc., or components thereof) and the one or more UEs (e.g., wireless device, IoT device, modem, etc. or component thereof). For example, the exemplary method and/or procedure shown in FIG. 11 can be implemented in an MME configured according to relevant 3GPP standards. Furthermore, the exemplary method and/or procedure shown in FIG. 11 can be utilized cooperatively with the exemplary methods and/or procedures shown in FIGS. 9-10 (described above), to provide various exemplary benefits described herein. Although FIG. 11 shows blocks in a particular order, this order is merely exemplary, and the operations of the exemplary method and/or procedure can be performed in a different order than shown in FIG. 11 and can be combined and/or divided into blocks having different functionality. Optional blocks or operations are shown by dashed lines.

The exemplary method and/or procedure can also include operations of block 810, where the network node can assign each of the one or more UEs to a respective individual UE group. The exemplary method and/or procedure can also include operations of block 820, where the network node can determine a mapping between a first plurality of available WUS codes and a second plurality of UE groups, wherein the second plurality comprises a plurality of individual UE groups and at least one combination UE group associated with multiple individual UE groups.

The exemplary method and/or procedure can also include operations of block 830, where the network node can send the determined mapping and the respective individual UE group assignments to the one or more UEs via the RAN (e.g., via the eNB(s) serving the cell(s) in which the one or more UEs are located). The exemplary method and/or procedure can also include operations of block 840, where the network node can send a paging request to a node in the RAN, wherein the paging request identifies at least a portion of the one or more UEs and the respective individual UE group assignments of the identified UEs. For example, the paging request can be sent to the eNB serving the cell in which the at least a portion of the one or more UEs are located.

Although various embodiments are described herein above in terms of methods, apparatus, devices, computer-readable medium and receivers, the person of ordinary skill will readily comprehend that such methods can be embodied by various combinations of hardware and software in various systems, communication devices, computing devices, control devices, apparatuses, non-transitory computer-readable media, etc. FIG. 12 shows a block diagram of an exemplary wireless device or user equipment (UE) 900 according to various embodiments of the present disclosure. For example, exemplary device 900 can be configured by execution of instructions, stored on a computer-readable medium, to perform operations corresponding to one or more of the exemplary methods and/or procedures described above.

Exemplary device 900 can comprise a processor 910 that can be operably connected to a program memory 920 and/or a data memory 930 via a bus 970 that can comprise parallel address and data buses, serial ports, or other methods and/or structures known to those of ordinary skill in the art. Program memory 920 comprises software code or program executed by processor 910 that facilitates, causes and/or programs exemplary device 900 to communicate using one or more wired or wireless communication protocols, including one or more wireless communication protocols standardized by 3GPP, 3GPP2, or IEEE, such as those commonly known as 5G/NR, LTE, LTE-A, UMTS, HSPA, GSM, GPRS, EDGE, 1×RTT, CDMA2000, 902.11 WiFi, HDMI, USB, Firewire, etc., or any other current or future protocols that can be utilized in conjunction with radio transceiver 940, user interface 950, and/or host interface 960.

For example, processor 910 can execute program code stored in program memory 920 that corresponds to MAC, RLC, PDCP, and RRC layer protocols standardized by 3GPP (e.g., for NR and/or LTE). As a further example, processor 910 can execute program code stored in program memory 920 that, together with radio transceiver 940, implements corresponding PHY layer protocols, such as Orthogonal Frequency Division Multiplexing (OFDM), Orthogonal Frequency Division Multiple Access (OFDMA), and Single-Carrier Frequency Division Multiple Access (SC-FDMA).

Program memory 920 can also comprises software code executed by processor 910 to control the functions of device 900, including configuring and controlling various components such as radio transceiver 940, user interface 950, and/or host interface 960. Program memory 920 can also comprise one or more application programs and/or modules comprising computer-executable instructions embodying any of the exemplary methods and/or procedures described herein. Such software code can be specified or written using any known or future developed programming language, such as e.g., Java, C++, C, Objective C, HTML, XHTML, machine code, and Assembler, as long as the desired functionality, e.g., as defined by the implemented method steps, is preserved. In addition, or as an alternative, program memory 920 can comprise an external storage arrangement (not shown) remote from device 900, from which the instructions can be downloaded into program memory 920 located within or removably coupled to device 900, so as to enable execution of such instructions.

Data memory 930 can comprise memory area for processor 910 to store variables used in protocols, configuration, control, and other functions of device 900, including operations corresponding to, or comprising, any of the exemplary methods and/or procedures described herein. Moreover, program memory 920 and/or data memory 930 can comprise non-volatile memory (e.g., flash memory), volatile memory (e.g., static or dynamic RAM), or a combination thereof. Furthermore, data memory 930 can comprise a memory slot by which removable memory cards in one or more formats (e.g., SD Card, Memory Stick, Compact Flash, etc.) can be inserted and removed. Persons of ordinary skill in the art will recognize that processor 910 can comprise multiple individual processors (including, e.g., multi-core processors), each of which implements a portion of the functionality described above. In such cases, multiple individual processors can be commonly connected to program memory 920 and data memory 930 or individually connected to multiple individual program memories and or data memories. More generally, persons of ordinary skill in the art will recognize that various protocols and other functions of device 900 can be implemented in many different computer arrangements comprising different combinations of hardware and software including, but not limited to, application processors, signal processors, general-purpose processors, multi-core processors, ASICs, fixed and/or programmable digital circuitry, analog baseband circuitry, radio-frequency circuitry, software, firmware, and middleware.

A radio transceiver 940 can comprise radio-frequency transmitter and/or receiver functionality that facilitates the device 900 to communicate with other equipment supporting like wireless communication standards and/or protocols. In some exemplary embodiments, the radio transceiver 940 includes a transmitter and a receiver that enable device 900 to communicate with various 5G/NR networks according to various protocols and/or methods proposed for standardization by 3GPP and/or other standards bodies. For example, such functionality can operate cooperatively with processor 910 to implement a PHY layer based on OFDM, OFDMA, and/or SC-FDMA technologies, such as described herein with respect to other figures.

In some exemplary embodiments, the radio transceiver 940 includes an LTE transmitter and receiver that can facilitate the device 900 to communicate with various LTE LTE-Advanced (LTE-A), and/or NR networks according to standards promulgated by 3GPP. In some exemplary embodiments of the present disclosure, the radio transceiver 940 includes circuitry, firmware, etc. necessary for the device 900 to communicate with various NR, NR-U, LTE, LTE-A, LTE-LAA, UMTS, and/or GSM/EDGE networks, also according to 3GPP standards. In some exemplary embodiments of the present disclosure, radio transceiver 940 includes circuitry, firmware, etc. necessary for the device 900 to communicate with various CDMA2000 networks, according to 3GPP2 standards.

In some exemplary embodiments of the present disclosure, the radio transceiver 940 is capable of communicating using radio technologies that operate in unlicensed frequency bands, such as IEEE 902.11 WiFi that operates using frequencies in the regions of 2.4, 5.6, and/or 60 GHz. In some exemplary embodiments of the present disclosure, radio transceiver 940 can comprise a transceiver that is capable of wired communication, such as by using IEEE 902.3 Ethernet technology. The functionality particular to each of these embodiments can be coupled with or controlled by other circuitry in the device 900, such as the processor 910 executing program code stored in program memory 920 in conjunction with, or supported by, data memory 930.

User interface 950 can take various forms depending on the particular embodiment of device 900, or can be absent from device 900 entirely. In some exemplary embodiments, user interface 950 can comprise a microphone, a loudspeaker, slidable buttons, depressible buttons, a display, a touchscreen display, a mechanical or virtual keypad, a mechanical or virtual keyboard, and/or any other user-interface features commonly found on mobile phones. In other embodiments, the device 900 can comprise a tablet computing device including a larger touchscreen display. In such embodiments, one or more of the mechanical features of the user interface 950 can be replaced by comparable or functionally equivalent virtual user interface features (e.g., virtual keypad, virtual buttons, etc.) implemented using the touchscreen display, as familiar to persons of ordinary skill in the art. In other embodiments, the device 900 can be a digital computing device, such as a laptop computer, desktop computer, workstation, etc. that comprises a mechanical keyboard that can be integrated, detached, or detachable depending on the particular exemplary embodiment. Such a digital computing device can also comprise a touch screen display. Many exemplary embodiments of the device 900 having a touch screen display are capable of receiving user inputs, such as inputs related to exemplary methods and/or procedures described herein or otherwise known to persons of ordinary skill in the art.

In some exemplary embodiments of the present disclosure, device 900 can comprise an orientation sensor, which can be used in various ways by features and functions of device 900. For example, the device 900 can use outputs of the orientation sensor to determine when a user has changed the physical orientation of the device 900's touch screen display. An indication signal from the orientation sensor can be available to any application program executing on the device 900, such that an application program can change the orientation of a screen display (e.g., from portrait to landscape) automatically when the indication signal indicates an approximate 90-degree change in physical orientation of the device. In this exemplary manner, the application program can maintain the screen display in a manner that is readable by the user, regardless of the physical orientation of the device. In addition, the output of the orientation sensor can be used in conjunction with various exemplary embodiments of the present disclosure.

A control interface 960 of the device 900 can take various forms depending on the particular exemplary embodiment of device 900 and of the particular interface requirements of other devices that the device 900 is intended to communicate with and/or control. For example, the control interface 960 can comprise an RS-232 interface, an RS-495 interface, a USB interface, an HDMI interface, a Bluetooth interface, an IEEE (“Firewire”) interface, an I²C interface, a PCMCIA interface, or the like. In some exemplary embodiments of the present disclosure, control interface 960 can comprise an IEEE 902.3 Ethernet interface such as described above. In some exemplary embodiments of the present disclosure, the control interface 960 can comprise analog interface circuitry including, for example, one or more digital-to-analog (D/A) and/or analog-to-digital (A/D) converters.

Persons of ordinary skill in the art can recognize the above list of features, interfaces, and radio-frequency communication standards is merely exemplary, and not limiting to the scope of the present disclosure. In other words, the device 900 can comprise more functionality than is shown in FIG. 12 including, for example, a video and/or still-image camera, microphone, media player and/or recorder, etc. Moreover, radio transceiver 940 can include circuitry necessary to communicate using additional radio-frequency communication standards including Bluetooth, GPS, and/or others. Moreover, the processor 910 can execute software code stored in the program memory 920 to control such additional functionality. For example, directional velocity and/or position estimates output from a GPS receiver can be available to any application program executing on the device 900, including various exemplary methods and/or computer-readable media according to various exemplary embodiments of the present disclosure.

FIG. 13 shows a block diagram of an exemplary network node 1000 according to various embodiments of the present disclosure. For example, exemplary network node 1000 can be configured by execution of instructions, stored on a computer-readable medium, to perform operations corresponding to one or more of the exemplary methods and/or procedures described above. In some exemplary embodiments, network node 1000 can comprise a base station, eNB, gNB, or one or more components thereof. For example, network node 1000 can be configured as a central unit (CU) and one or more distributed units (DUs) according to NR gNB architectures specified by 3GPP. More generally, the functionally of network node 1000 can be distributed across various physical devices and/or functional units, modules, etc.

Network node 1000 comprises processor 1010 which is operably connected to program memory 1020 and data memory 1030 via bus 1070, which can comprise parallel address and data buses, serial ports, or other methods and/or structures known to those of ordinary skill in the art.

Program memory 1020 comprises software code (e.g., program instructions) executed by processor 1010 that can configure and/or facilitate network node 1000 to communicate with one or more other devices using protocols according to various embodiments of the present disclosure, including one or more exemplary methods and/or procedures discussed above. Program memory 1020 can also comprise software code executed by processor 1010 that can facilitate and specifically configure network node 1000 to communicate with one or more other devices using other protocols or protocol layers, such as one or more of the PHY, MAC, RLC, PDCP, and RRC layer protocols standardized by 3GPP for LTE, LTE-A, and/or NR, or any other higher-layer protocols utilized in conjunction with radio network interface 1040 and core network interface 1050. By way of example and without limitation, core network interface 1050 can comprise the S1 interface and radio network interface 1050 can comprise the Uu interface, as standardized by 3GPP. Program memory 1020 can further comprise software code executed by processor 1010 to control the functions of network node 1000, including configuring and controlling various components such as radio network interface 1040 and core network interface 1050.

Data memory 1030 can comprise memory area for processor 1010 to store variables used in protocols, configuration, control, and other functions of network node 1000. As such, program memory 1020 and data memory 1030 can comprise non-volatile memory (e.g., flash memory, hard disk, etc.), volatile memory (e.g., static or dynamic RAM), network-based (e.g., “cloud”) storage, or a combination thereof. Persons of ordinary skill in the art will recognize that processor 1010 can comprise multiple individual processors (not shown), each of which implements a portion of the functionality described above. In such case, multiple individual processors may be commonly connected to program memory 1020 and data memory 1030 or individually connected to multiple individual program memories and/or data memories. More generally, persons of ordinary skill in the art will recognize that various protocols and other functions of network node 1000 may be implemented in many different combinations of hardware and software including, but not limited to, application processors, signal processors, general-purpose processors, multi-core processors, ASICs, fixed digital circuitry, programmable digital circuitry, analog baseband circuitry, radio-frequency circuitry, software, firmware, and middleware.

Radio network interface 1040 can comprise transmitters, receivers, signal processors, ASICs, antennas, beamforming units, and other circuitry that enables network node 1000 to communicate with other equipment such as, in some embodiments, a plurality of compatible user equipment (UE). In some exemplary embodiments, radio network interface can comprise various protocols or protocol layers, such as the PHY, MAC, RLC, PDCP, and RRC layer protocols standardized by 3GPP for LTE, LTE-A, LTE-LAA, NR, NR-U, etc.; improvements thereto such as described herein above; or any other higher-layer protocols utilized in conjunction with radio network interface 1040. According to further exemplary embodiments of the present disclosure, the radio network interface 1040 can comprise a PHY layer based on OFDM, OFDMA, and/or SC-FDMA technologies. In some embodiments, the functionality of such a PHY layer can be provided cooperatively by radio network interface 1040 and processor 1010 (including program code in memory 1020).

Core network interface 1050 can comprise transmitters, receivers, and other circuitry that enables network node 1000 to communicate with other equipment in a core network such as, in some embodiments, circuit-switched (CS) and/or packet-switched Core (PS) networks. In some embodiments, core network interface 1050 can comprise the S1 interface standardized by 3GPP. In some embodiments, core network interface 1050 can comprise the NG interface standardized by 3GPP. In some exemplary embodiments, core network interface 1050 can comprise one or more interfaces to one or more SGWs, MMEs, SGSNs, GGSNs, and other physical devices that comprise functionality found in GERAN, UTRAN, EPC, 5GC, and CDMA2000 core networks that are known to persons of ordinary skill in the art. In some embodiments, these one or more interfaces may be multiplexed together on a single physical interface. In some embodiments, lower layers of core network interface 1050 can comprise one or more of asynchronous transfer mode (ATM), Internet Protocol (IP)-over-Ethernet, SDH over optical fiber, T1/E1/PDH over a copper wire, microwave radio, or other wired or wireless transmission technologies known to those of ordinary skill in the art.

OA&M interface 1060 can comprise transmitters, receivers, and other circuitry that enables network node 1000 to communicate with external networks, computers, databases, and the like for purposes of operations, administration, and maintenance of network node 1000 or other network equipment operably connected thereto. Lower layers of OA&M interface 1060 can comprise one or more of asynchronous transfer mode (ATM), Internet Protocol (IP)-over-Ethernet, SDH over optical fiber, T1/E1/PDH over a copper wire, microwave radio, or other wired or wireless transmission technologies known to those of ordinary skill in the art. Moreover, in some embodiments, one or more of radio network interface 1040, core network interface 1050, and OA&M interface 1060 may be multiplexed together on a single physical interface, such as the examples listed above.

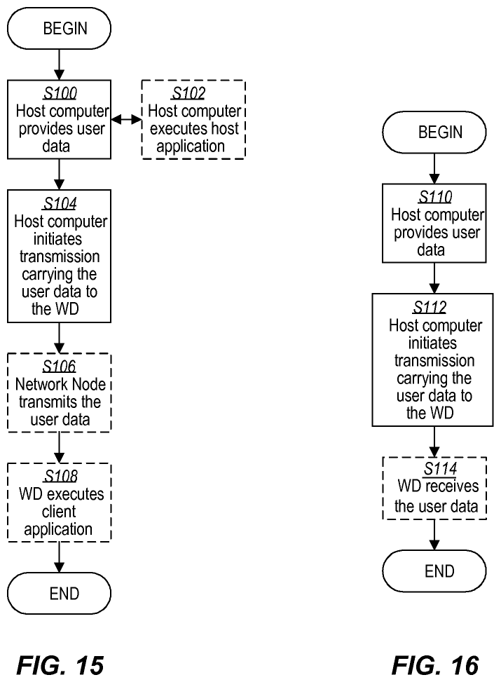

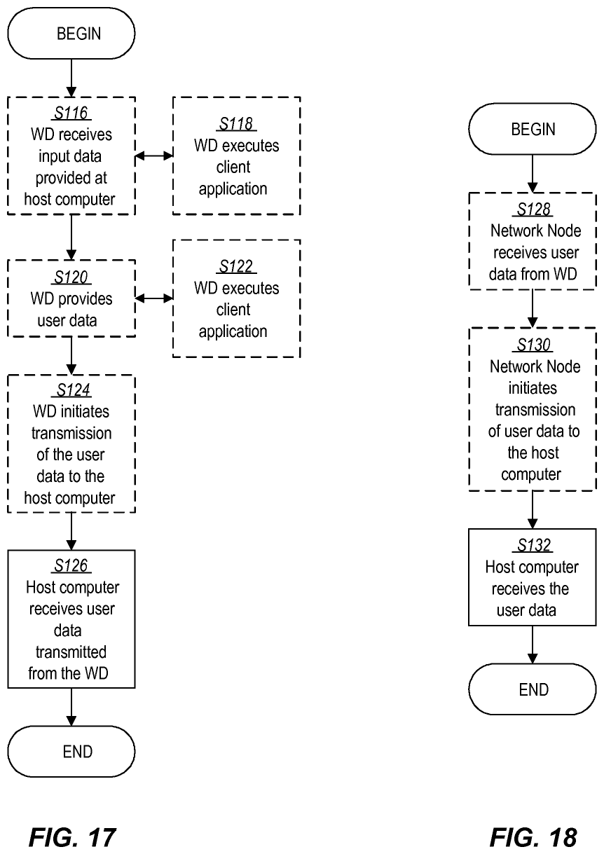

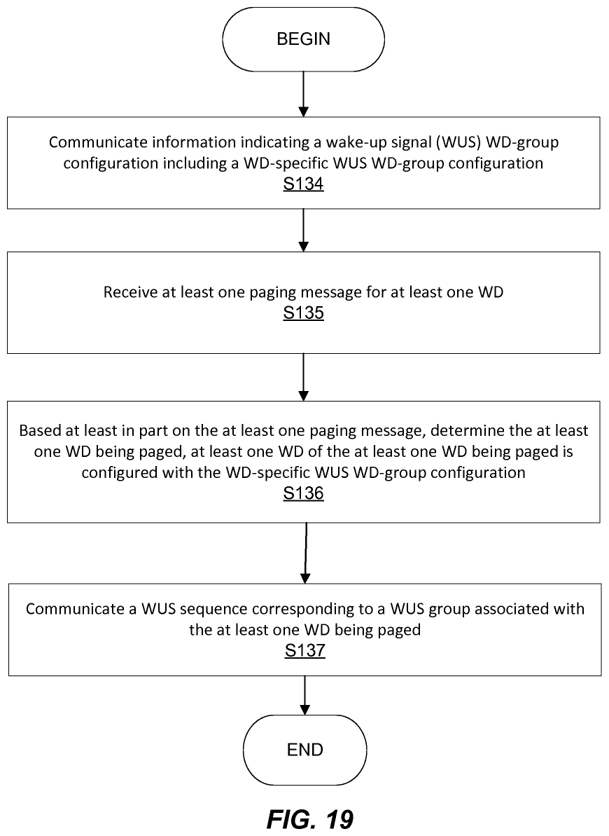

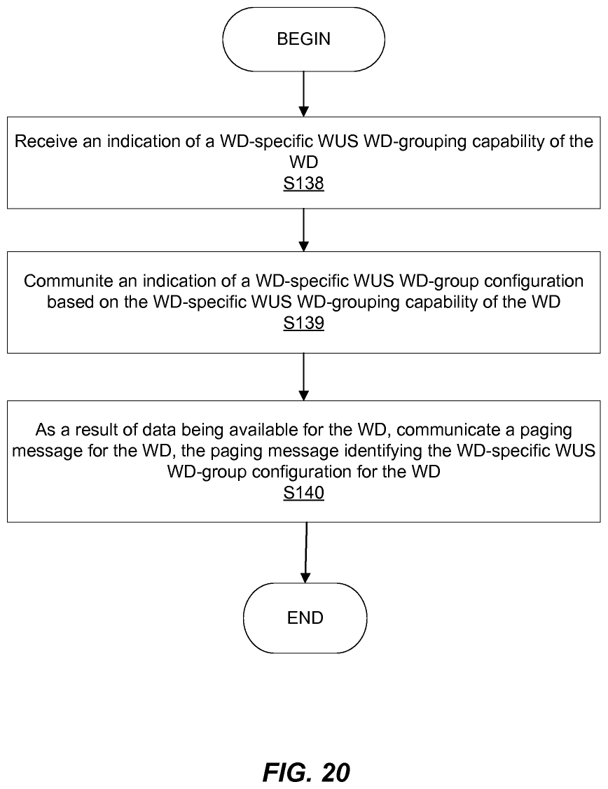

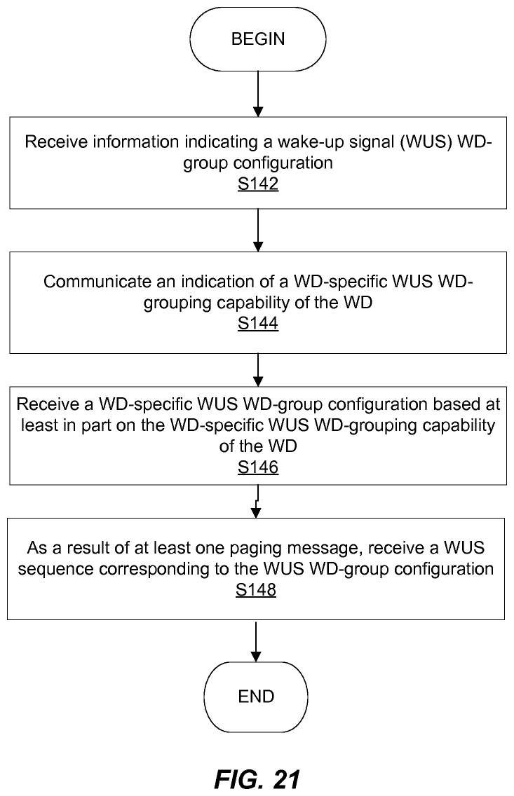

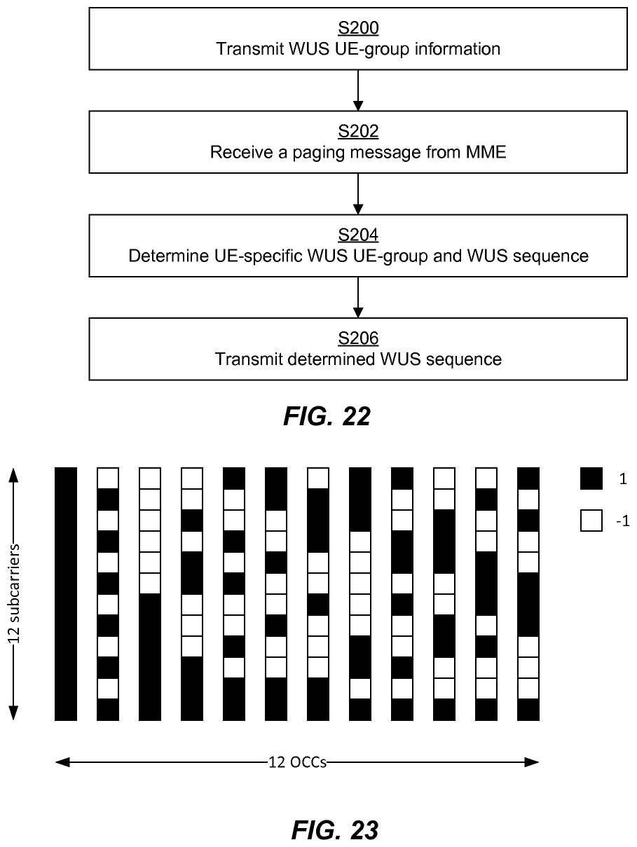

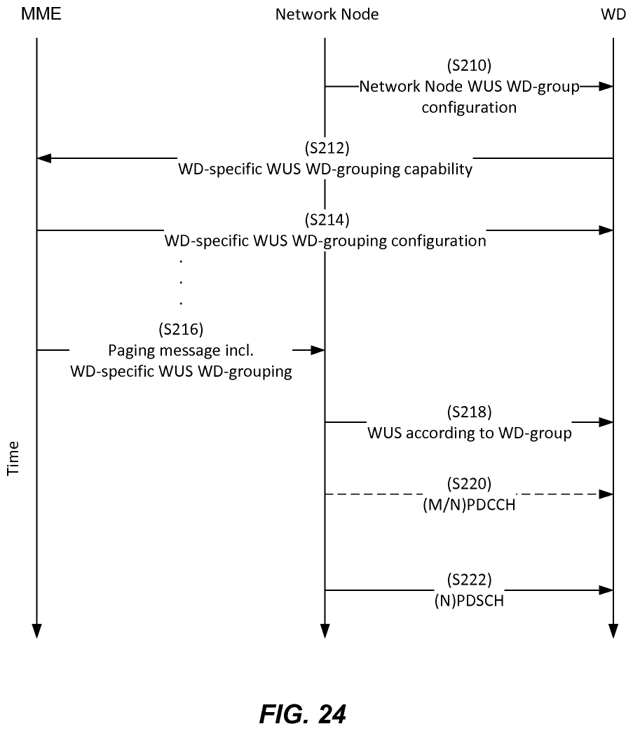

FIG. 14 is a block diagram of an exemplary communication network configured to provide over-the-top (OTT) data services between a host computer and a user equipment (UE), according to one or more exemplary embodiments of the present disclosure. UE 1110 can communicate with radio access network (RAN) 1130 over radio interface 1120, which can be based on protocols described above including, e.g., LTE, LTE-A, and 5G/NR. For example, UE 1110 can be configured and/or arranged as shown in other figures discussed above. RAN 1130 can include one or more network nodes (e.g., base stations, eNBs, gNBs, controllers, etc.) operable in licensed spectrum bands, as well one or more network nodes operable in unlicensed spectrum (using, e.g., LAA or NR-U technology), such as a 2.4-GHz band and/or a 5-GHz band. In such cases, the network nodes comprising RAN 1130 can cooperatively operate using licensed and unlicensed spectrum.

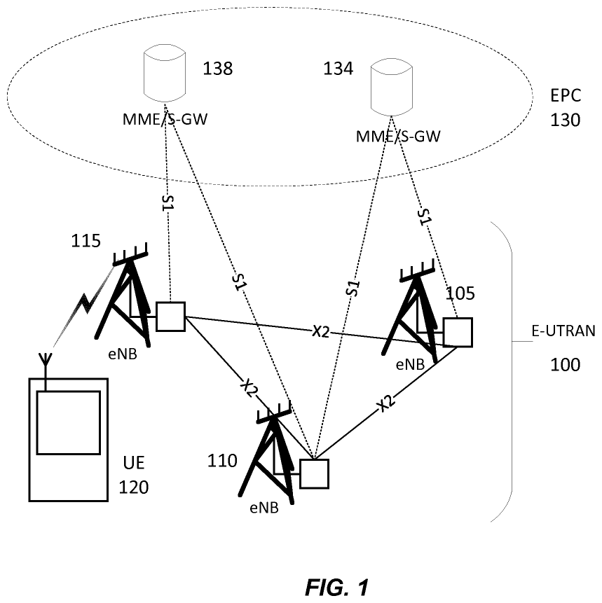

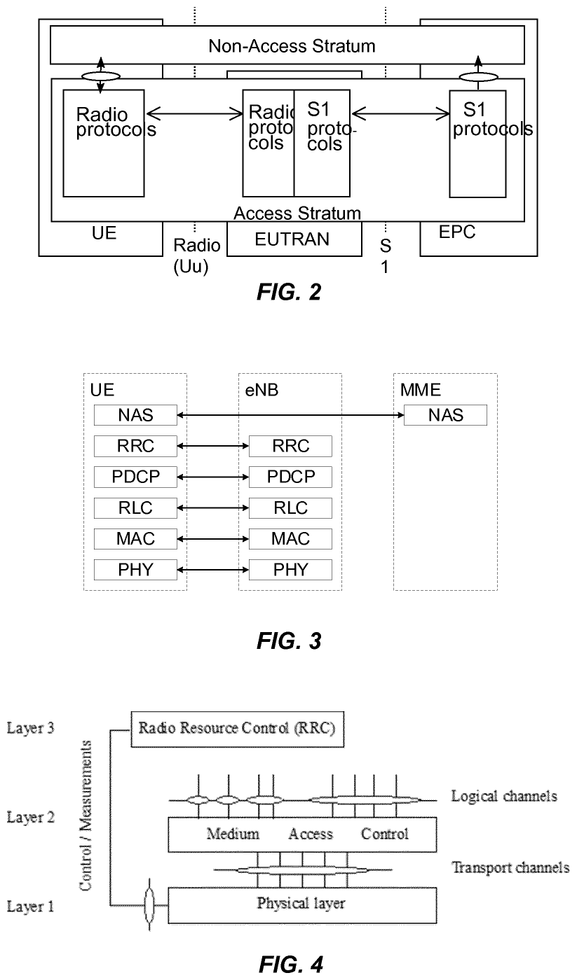

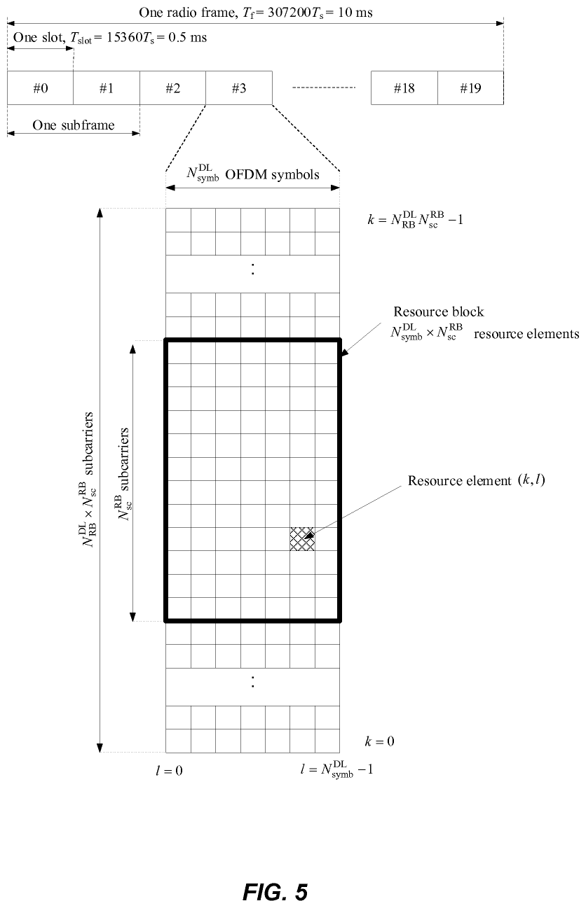

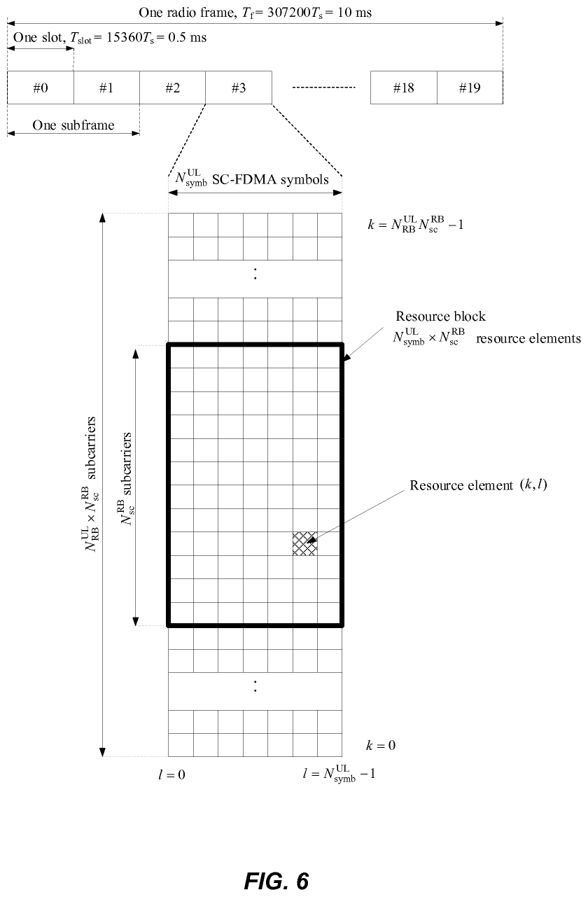

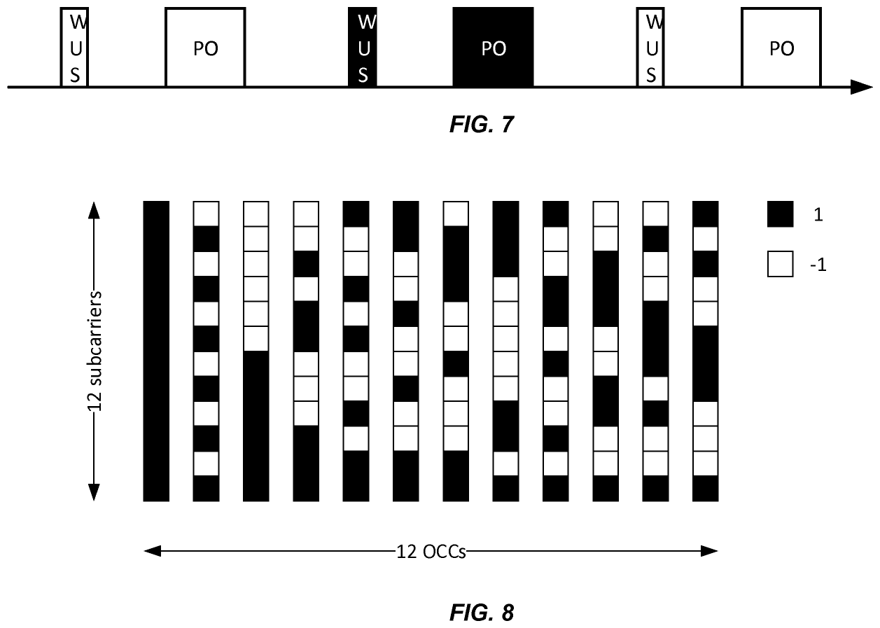

RAN 1130 can further communicate with core network 1140 according to various protocols and interfaces described above. For example, one or more apparatus (e.g., base stations, eNBs, gNBs, etc.) comprising RAN 1130 can communicate to core network 1140 via core network interface 1150 described above. In some exemplary embodiments, RAN 1130 and core network 1140 can be configured and/or arranged as shown in other figures discussed above. For example, eNBs comprising an E-UTRAN 1130 can communicate with an EPC core network 1140 via an S1 interface, such as shown in FIG. 1. As another example, gNBs comprising a NR RAN 1130 can communicate with a 5GC core network 1130 via an NG interface.

Core network 1140 can further communicate with an external packet data network, illustrated in FIG. 14 as Internet 1150, according to various protocols and interfaces known to persons of ordinary skill in the art. Many other devices and/or networks can also connect to and communicate via Internet 1150, such as exemplary host computer 1160. In some exemplary embodiments, host computer 1160 can communicate with UE 1110 using Internet 1150, core network 1140, and RAN 1130 as intermediaries. Host computer 1160 can be a server (e.g., an application server) under ownership and/or control of a service provider. Host computer 1160 can be operated by the OTT service provider or by another entity on the service provider's behalf.

For example, host computer 1160 can provide an over-the-top (OTT) packet data service to UE 1110 using facilities of core network 1140 and RAN 1130, which can be unaware of the routing of an outgoing/incoming communication to/from host computer 1160. Similarly, host computer 1160 can be unaware of routing of a transmission from the host computer to the UE, e.g., the routing of the transmission through RAN 1130. Various OTT services can be provided using the exemplary configuration shown in FIG. 14 including, e.g., streaming (unidirectional) audio and/or video from host computer to UE, interactive (bidirectional) audio and/or video between host computer and UE, interactive messaging or social communication, interactive virtual or augmented reality, etc.

The exemplary network shown in FIG. 14 can also include measurement procedures and/or sensors that monitor network performance metrics including data rate, latency and other factors that are improved by exemplary embodiments disclosed herein. The exemplary network can also include functionality for reconfiguring the link between the endpoints (e.g., host computer and UE) in response to variations in the measurement results. Such procedures and functionalities are known and practiced; if the network hides or abstracts the radio interface from the OTT service provider, measurements can be facilitated by proprietary signaling between the UE and the host computer.

The exemplary embodiments described herein provide efficient techniques for RAN 1130 operation in unlicensed spectrum, particularly to indicate, assign, and/or configure time resources for UEs—such as UE 1110—to transmit on an UL shared channel in unlicensed spectrum. For example, by assigning different transmission starting symbols within a timeslot, such techniques can reduce UL contention between UEs that are assigned the same UL timeslot resources. When used in NR UEs (e.g., UE 1110) and gNBs (e.g., gNBs comprising RAN 1130), exemplary embodiments described herein can provide various improvements, benefits, and/or advantages to OTT service providers and end-users, including more consistent data throughout and fewer delays without excessive UE power consumption or other reductions in user experience.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various different exemplary embodiments can be used together with one another, as well as interchangeably therewith, as should be understood by those having ordinary skill in the art. In addition, certain terms used in the present disclosure, including the specification, drawings and exemplary embodiments thereof can be used synonymously in certain instances, including, but not limited to, e.g., data and information. It should be understood that, while these words and/or other words that can be synonymous to one another, can be used synonymously herein, that there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

Example embodiments of the techniques and apparatus described herein include, but are not limited to, the following enumerated embodiments:

1. A method for transmitting a wake-up signal (WUS) to one or more user equipment (UEs) in a cell of a radio access network (RAN), the method comprising:
receiving a paging message identifying at least a portion of the UEs in the cell;
selecting a WUS code associated with the identified UEs, wherein the WUS code is selected from a first plurality of available WUS codes that are mapped to a second plurality of UE groups; and
transmitting the WUS based on the selected WUS code.
   2. The method of embodiment 1, further comprising:
determining the mapping between the first plurality of available WUS codes and the second plurality of UE groups; and
transmitting the determined mapping to the one or more UEs.
   3. The method of embodiment 3, wherein determining the mapping comprises receiving the mapping from another network node in the RAN or in a core network associated with the RAN.
   4. The method of embodiment 3, wherein determining the mapping comprises reading configuration information from a storage medium.
   5. The method of embodiment 3, wherein determining the mapping comprises selecting the number of UE groups comprising the second plurality.
   6. The method of embodiment 5, wherein selecting the number of UE groups is based on at least one of the following: the number of available WUS codes, respective false-alarm rates for the available WUS codes, paging-rate requirements of the one or more UEs in the cell, and capabilities of the one or more UEs.
   7. The method of embodiment 6, further comprising determining the paging-rate requirements of the one or more UEs based on the values of a plurality of paging-related parameters associated with the respective UEs.
   8. The method of any of embodiments 2-7, wherein the determined mapping is transmitted via one or more of the following: broadcast system information and radio resource control (RRC) messages.
   9. The method of any of embodiments 1-8, wherein the second plurality of UE groups includes a plurality of individual UE groups.
   10. The method of any of embodiments 1-9, wherein the second plurality of UE groups includes only individual UE groups.
   11. The method of any of embodiments 1-10, wherein the second plurality is equal to the first plurality.
   12. The method of embodiment 9, wherein the second plurality of UE groups also includes a common UE group associated with all individual UE groups.
   13. The method of embodiment 9, wherein the second plurality of UE groups includes one or more combination UE groups, wherein each combination UE group is associated with a particular combination of multiple individual UE groups.
   14. The method of any of embodiments 12-13, wherein at least one of the first plurality of WUS codes is not associated with a paging opportunity (PO).
   15. The method of any of embodiments 1-14, further comprising receiving, for each of the identified UEs, an identifier of an individual UE group to the particular UE is assigned, wherein selecting the WUS code is based on the identified individual UE groups.
   16. The method of embodiment 15, wherein the identified UEs are associated with a plurality of individual UE groups, and selecting the WUS code comprises selecting an available WUS code corresponding to a combination UE group that includes a minimum number of individual UE groups other than the one or more individual UE groups.
   17. The method of any of embodiments 1-16, wherein the available WUS codes comprise a first plurality of frequency-domain orthogonal cover codes (OCCs) applied over a single time-domain symbol.
   18. The method of any of embodiments 1-16, wherein the available WUS codes comprise a first plurality of frequency-domain scrambling codes applied over multiple time-domain symbols.
   19. A method for receiving a wake-up signal (WUS) transmitted by a network node in a radio access network (RAN), the method comprising:
receiving information comprising a mapping between a first plurality of available WUS codes and a second plurality of UE groups, wherein the second plurality comprises a plurality of individual UE groups and at least one combination UE group associated with multiple individual UE groups;
receiving an assignment to one of the individual UE groups;
receiving a signal during a period when a WUS is expected to be transmitted; and
attempting to detect, in the received signal, a WUS corresponding to any of a third plurality of WUS codes, wherein the third plurality comprises a WUS code associated with the assigned individual UE group and one or more WUS codes associated with respective one or more combination UE groups.
   20. The method of embodiment 19, wherein the at least one combination UE group includes a common UE group associated with all individual UE groups.
   21. The method of embodiments 19-20, wherein the at least one combination UE group includes one or more combination UE groups associated with respective subsets of the individual UE groups.
   22. The method of any of embodiments 19-21, further comprising, if the WUS corresponding to any of the third plurality of WUS codes is detected, receiving a paging signal during a subsequent paging occasion (PO) at a predefined later time relative to the WUS.
   23. The method of any of embodiments 19-21, further comprising, if the WUS corresponding to a particular one of the third plurality of WUS codes is detected, receiving a physical downlink shared channel (PDSCH) at a predefined later time relative to the WUS or to an intervening paging occasion (PO) associated with the WUS, without attempting to receive a paging signal during the PO.
   24. The method of any of embodiments 19-23, wherein the available WUS codes comprise a first plurality of frequency-domain orthogonal cover codes (OCCs) applied over a single time-domain symbol.
   25. The method of any of embodiments 19-23, wherein the available WUS codes comprise a first plurality of frequency-domain scrambling codes applied over multiple time-domain symbols.
   26. The method of any of embodiments 19-25, wherein the mapping and the assignment are received from a mobility management entity (MME).
   27. A method for paging one or more user equipment (UE) based on wake-up signals (WUS) transmitted in a radio access network (RAN), comprising
assigning each of the one or more UEs to a respective individual UE group;
determining a mapping between a first plurality of available WUS codes and a second plurality of UE groups, wherein the second plurality comprises a plurality of individual UE groups and at least one combination UE group associated with multiple individual UE groups;
sending the determined mapping and the respective individual UE group assignments to the one or more UEs via the RAN;
sending a paging request to a node in the RAN, wherein the paging request identifies at least a portion of the one or more UEs and the respective individual UE group assignments of the identified UEs.
   28. A network node configured to transmit a wake-up signal (WUS) to one or more user equipment (UEs) in a radio access network (RAN), the network node comprising:
communication circuitry configured to communicate with the UEs; and processing circuitry operatively associated with the communication circuitry and configured to perform operations corresponding to the methods of any of exemplary embodiments 1-18.
   29. A non-transitory, computer-readable medium storing computer-executable instructions that, when executed by at least one processor of a network node, configure the network node to perform operations corresponding to the methods of any of exemplary embodiments 1-18.
   30. A user equipment (UE) configured to receive a wake-up signal (WUS) transmitted by a network node in a radio access network (RAN), the UE comprising:
communication circuitry configured to communicate with a network node; and
processing circuitry operatively associated with the communication circuitry and configured to perform operations corresponding to the methods of any of exemplary embodiments 19-26.
   31. A non-transitory, computer-readable medium storing computer-executable instructions that, when executed by at least one processor of a user equipment (UE), configure the UE to perform operations corresponding to the methods of any of exemplary embodiments 19-28.
   32. A network node configured to page one or more user equipment (UE) based on wake-up signals (WUS) transmitted in a radio access network (RAN), the network node comprising:
communication circuitry configured to communicate with the RAN; and
processing circuitry operatively associated with the communication circuitry and configured to perform operations corresponding to the method of exemplary embodiment 27.
   33. A non-transitory, computer-readable medium storing computer-executable instructions that, when executed by at least one processor of a network node, configure the network node to perform operations corresponding to the method of exemplary embodiment 27.

FIG. 15 is a flowchart illustrating an exemplary method implemented in a communication system, such as, for example, the communication system of FIG. 1, in accordance with one embodiment. The communication system may include a service node 134, 138, a network node 115 and a wireless device, WD, 120, which may be those described with reference to FIG. 1. The service node may be a server and/or a host computer in the EPC 130. In a first step of the method, the host computer 24 provides user data (block S100). In an optional substep of the first step, the service node 134, 138 provides the user data by executing a host application, such as, for example, the service node 134, 138 (block S102). In a second step, the service node 134, 138 initiates a transmission carrying the user data to the WD 120 (block S104). In an optional third step, the network node 115 transmits to the WD 120 the user data which was carried in the transmission that the service node 134, 138 initiated, in accordance with the teachings of the embodiments described throughout this disclosure (block S106). In an optional fourth step, the WD 120 executes a client application, such as, for example, a client application, associated with the host application executed by the service node 134, 138 (block S108).

FIG. 16 is a flowchart illustrating an exemplary method implemented in a communication system, such as, for example, the communication system of FIG. 1, in accordance with one embodiment. The communication system may include a service node 134, 138, a network node 115 and a WD 120, which may be those described with reference to FIG. 1. In a first step of the method, the service node 134, 138 provides user data (block S110). In an optional substep (not shown) the service node 134, 138 provides the user data by executing a host application, such as, for example, a host application. In a second step, the service node 134, 138 initiates a transmission carrying the user data to the WD 120 (block S112). The transmission may pass via the network node 115, in accordance with the teachings of the embodiments described throughout this disclosure. In an optional third step, the WD 120 receives the user data carried in the transmission (block S114).

FIG. 17 is a flowchart illustrating an exemplary method implemented in a communication system, such as, for example, the communication system of FIG. 1, in accordance with one embodiment. The communication system may include a service node 134, 138, a network node 115 and a WD 120, which may be those described with reference to FIG. 1. In an optional first step of the method, the WD 120 receives input data provided by the service node 134, 138 (block S116). In an optional substep of the first step, the WD 120 executes the client application, which provides the user data in reaction to the received input data provided by the service node 134, 138 (block S118). Additionally or alternatively, in an optional second step, the WD 120 provides user data (block S120). In an optional substep of the second step, the WD 120 provides the user data by executing a client application, such as, for example, a client application (block S122). In providing the user data, the executed client application may further consideruser input received from the user. Regardless of the specific manner in which the user data was provided, the WD 120 may initiate, in an optional third substep, transmission of the user data to the service node 134, 138 (block S124). In a fourth step of the method, the host computer 24 receives the user data transmitted from the WD 120, in accordance with the teachings of the embodiments described throughout this disclosure (block S126).

FIG. 18 is a flowchart illustrating an exemplary method implemented in a communication system, such as, for example, the communication system of FIG. 1, in accordance with one embodiment. The communication system may include a service node 134, 138, a network node 115 and a WD 120, which may be those described with reference to FIG. 1. In an optional first step of the method, in accordance with the teachings of the embodiments described throughout this disclosure, the network node 115 receives user data from the WD 120 (block S128). In an optional second step, the network node 115 initiates transmission of the received user data to the service node 134, 138 (block S130). In a third step, the host computer 24 receives the user data carried in the transmission initiated by the network node 16 (block S132). FIG. 19 is a flowchart of an exemplary process in a network node 120 (e.g., gNB) according to the principles in this disclosure. The method includes communicating (block S134), such as via a WUS group configuration unit, information indicating a wake-up signal (WUS) WD-group configuration including a WD-specific WUS WD-group configuration. The method includes receiving (block S135), such as via the WUS group configuration unit, at least one paging message for at least one WD 120. The method includes, based at least in part on the at least one paging message, determining (block S136) the at least one WD being paged, at least one WD of the at least one WD being paged is configured with the WD-specific WUS WD-group configuration. The method includes communicating (block S137), such as via the WUS group configuration unit, a WUS sequence corresponding to a WUS group associated with the at least one WD being paged.

FIG. 20 is a flowchart of an exemplary alternative process in a network node 115 (e.g., MME) according to the principles in this disclosure. The method includes receiving (block S138), such as via the WUS group configuration unit, an indication of a WD-specific WUS WD-grouping capability ofthe WD 120. The method includes communicating (block S139), such as via the WUS group configuration unit, an indication of a WD-specific WUS WD-group configuration based on the WD-specific WUS WD-grouping capability of the WD 120. The method includes, as a result of data being available for the WD 120, communicating (block S140) a paging message for the WD 120, the paging message identifying the WD-specific WUS WD-group configuration for the WD 120. In some embodiments of this process, the paging message further includes information permitting the WD 120 to decode a downlink data message without decoding a corresponding downlink control channel.

In some embodiments, communicating the information comprises communicating the information indicating the WUS WD-group configuration in system information (SI). In some embodiments, communicating the WUS sequence comprises communicating the WUS sequence according to: a common WUS WD-group configuration, if the at least one WD being paged includes a WD with a non-WD-specific WUS WD-group configuration; and the WD-specific WUS WD-group configuration, if the at least one WD being paged includes only a WD configured with the WD-specific WUS WD-group configuration.

FIG. 21 is a flowchart of an exemplary process in a wireless device 120 according to some embodiments of the present disclosure. The method includes receiving (block S142), such as via a WUS sequence unit, information indicating a wake-up signal (WUS) WD-group configuration. The method includes communicating (block S144), such as via the WUS sequence unit, an indication of a WD-specific WUS WD-grouping capability of the WD 120. The method includes receiving (block S146), such as via the WUS sequence unit, a WD-specific WUS WD-group configuration based at least in part on the WD-specific WUS WD-grouping capability of the WD 120. The method includes, as a result of at least one paging message, receiving (block S148), such as via the WUS sequence unit, a WUS sequence corresponding to the WUS WD-group configuration.

In some embodiments, the method further includes, based at least in part on information in the WD-specific WUS WD-group configuration, decoding, such as via the WUS sequence unit, a downlink data message from the network node 115 without decoding a corresponding control channel. In some embodiments, receiving the information includes receiving the information indicating the WUS WD-group configuration in system information (SI). In some embodiments, the WUS sequence is based at least in part on: a common WUS WD-group configuration, if at least one WD 120 being paged by the at least one paging message includes a WD 120 with a non-WD-specific WUS WD-group configuration; and the WD-specific WUS WD-group configuration, if the at least one WD 120 being paged includes only a WD 120 configured with the WD-specific WUS WD-group configuration.

Having described some embodiments for facilitating WD-specific group WUS configurations, a more detailed description of at least some of the embodiments are described below.

This disclosure provides at least a few different aspects, which may be referred to herein generally as a paging aspect, a configuration aspect, a decoding aspect, and a system aspect. For example, a paging aspect is provided, where a network node 115 (e.g., eNB) pages a device (e.g., WD 120) with a WUS code according to the principles in this disclosure. In some embodiments, a configuration aspect is provided, where the WD 120 is configured to use the WD-specific WUS code. Further aspects may include a WD decoding aspect and a WD configuration aspect, as well as, a system aspect, which are described in more detail below.

A configuration aspect of the disclosure may provide a method in a network node 115 (e.g., MME) for configuring a device with WD-specific WUS WD-grouping.

In one embodiment of this disclosure, the WD 120 is configured to a specific WD-group over, for example, NAS signaling. In some embodiments, RRC signaling could also be considered for RAN-paging in INACTIVE state for NR. The configured WUS WD-group may be stored at both the WD 22 and the network node 115, e.g. added to the WD-context in the MME. Which WD-group a WD 120 is configured to could be based at least in part on any combination of the following parameters:
The WD's 120 paging probability;
The WD's 120 DRX or eDRX cycle and/or parameters;
The WD's 120 Quality of Service (QoS) or Quality of Service Class Indicator (QCI);
The WD's 120 subscription information;
The Coverage Enhancement information of the WD 120;
The allocation of other WDs to the WD-groups;
Historical or statistical traffic/paging records;
The WD's 120 Subscription Based WD Differentiation Information' (see e.g., 3GPP specifications TS 36.423 and 36.413). For example, based at least in part on the parameters Periodic Time, Battery Indication, Traffic Profile, Stationary Indication, Scheduled Communication Time, etc.;
Any information in the WD 120 context; and/or
The WD's 120 application.

A prerequisite of the configuration may be, for example, that the Rel-16 WD-group WUS is added as a WD capability, or connected to a new WD category, and that the network node 16 becomes aware of this WD capability, as party of the other WD capabilities signaled to the MME. The WUS-group may then be added to the WD radio paging capabilities, which may be included in the paging message from the MME to the base station (e.g., eNB) when the WD 120 is later paged. The network node 115 (e.g., eNB) may take this information into account for the actual paging transmission as described below. In an alternative embodiment, the WUS WD-group can be configured over radio resource control (RRC) signaling and may then be signaled back to the MME for storage.

In some embodiments, a paging aspect of the disclosure provides for a method in a network node 115 (e.g., eNB), configured with a WD-specific WUS WD-grouping configuration, for paging at least one WD 120, the at least one WD 120 configured with WD-specific WUS WD-grouping. An example of this method is described with reference to FIG. 22. In a first step (block S200), the network node 115 (e.g., eNB) transmits information about a WUS WD-group configuration including WD-specific WUS groups. The configuration may indicate a WUS WD-group configuration where a subset of the groups is used for WD-specific WUS WD-grouping and the remaining codes are used in a predetermined WD-grouping scheme based at least in part on, e.g., WD_ID. In a second step (block S202), the network node 115 (e.g., eNB) may receive a paging message from another network node (e.g., an MME) targeting the at least one WD 120. In a third step (block S204), based at least in part on the received paging message, the network node 115 (e.g., eNB) may determine the paged WD 120 being configured with the WD-specific WUS WD-group. In a fourth step (block S206), the network node 115 (e.g., eNB) transmits a sequence corresponding to the WD-specific WUS WD-group of the paged WD 120.

Correspondingly, the WD 120, if capable of and configured with the Rel-16 WD-group WUS, can monitor paging according to the configured WUS WD-group.

In one embodiment, the common WUS WD-group configuration information is broadcast in system information. Hence, even though a WD 120 has woken up in another cell, it may still take advantage of the WD-specific WUS WD-grouping if the same scheme is used in the new cell. Note that, if the WD 120 is configured to WUS WD-group N, paging with WUS in WD-group N could correspond to different physical resources (e.g., code, sequence, frequency resources, time resources, etc.) in the new cell, but since the configuration is broadcasted in system information both WD 120 and the network node (e.g., eNB) may still have a common knowledge about the WD-specific WUS WD-group.

In an alternative embodiment, the common WUS WD-group configuration is provided to the WD 120 over dedicated signaling (e.g., RRC, NAS, etc.) and stored along with the dedicated WUS WD-group configuration (containing at least the information of which WD-group the WD 120 belongs to).

In one embodiment, the paging message includes WD 120 information agreed from NAS signaling between the WD 120 and the network (e.g., MME). This may have been previously agreed in the configuration of the WD-specific WUS WD-group. This information may include at least the WD-specific code(s) that have been allocated to the paged at least one WD 120. Optionally, the information in the paging message may also include a WUS WD-grouping scheme that the code is based at least in part on. In an alternative embodiment, the information in the paging message may just include the group number (or other group identifier), and the group number/ID may be mapped to different physical WUS resources in different cells/eNBs as described above.

In yet another embodiment, the WD-specific configuration may include further paging information, e.g., a predefined (N)PDSCH location, such that the WD 120 may refrain from decoding the subsequent (M/N)PDCCH. This paging information may also include information otherwise found in an (M/N)PDCCH paging message, such as, for example, time and frequency offset from the PO, MCS, etc.

In yet another embodiment, the different WD-groups may be formed from a WUS base sequence, e.g., a scrambled Zadoff-Chu (ZC) sequence, upon which the WD-groups are coded using frequency domain orthogonal cover codes (OCCs), such as the example as illustrated in FIG. 23. In a related embodiment, the scrambling code may be varied based at least in part on the codes, or the ZC root index or shift may be used to indicate the code set.

In one embodiment, the WUS sequence to be transmitted may be determined from the one or more of the following paging rule(s):
If the at least one WD 120 includes a WD 120 without a non-WD-specific WUS WD-group configuration, or WDs 120 with different WD-specific WUS WD-group configurations, a WUS sequence corresponding to a non-WD-specific WD-group is transmitted, e.g., a WUS sequence common for all WDs 120, or
If all of the at least one paged WD(s) 120 belong to the same WD-specific WUS WD-group, the WUS sequence corresponding to that WD-group is transmitted.

TABLE 3
Example of relation between WD-groups
and respective WUS codes.

| | WD-group | | | |
|---|---|---|---|---|
| Code | 0 | 1 | 2 | 3 |
| 0 | Yes | Yes | Yes | Yes |
| 1 | Yes | | | |
| 2 | | Yes | | |
| 3 | | | Yes | |

| | |
|---|---|
| 4 | WD-specific |
| 5 | WD-specific |
| 6 | WD-specific |
| 7 | WD-specific |
| 8 | WD-specific |
| 9 | WD-specific |
| 10 | WD-specific |
| 11 | WD-specific |

A system aspect of the disclosure may be considered providing a system (e.g., including at least an MME, a base station, and a WD) that configures a WD-specific WUS WD-grouping to at least one WD 120 with such capabilities, such as for example according to the flow diagram of FIG. 24. In this example, the base station (e.g., eNB, network node 115, etc.) transmits information about a WD-specific WUS WD-grouping configuration (step S210). In one embodiment, this is done in system information (SI). The WD 120 may inform the MME about its WD-group capabilities (step S212) and is in turn configured by the MME accordingly (step S214). In one embodiment, this configuration also includes (M/N)PDCCH information about where to read a subsequent (n)PDSCH, hence eliminating the need for reading (M/N)PDCCH thereby reducing latency and power consumption. Upon paging, a paging message is sent from the MME to the network node 115 (step S216). The information about the WD-specific WUS WD-grouping may be included in the paging message. The network node 115 configures the WUS according to the paging message and transmits the corresponding WUS sequence (step S218). In one embodiment, the WD-specific WUS sequence is selected in the case where only one WD 120 is paged. In another embodiment, when multiple paging messages, or a direct indication message, is received for the same PO, a WUS sequence that all paged WDs 120 are attentive to is selected, e.g., a WUS sequence corresponding to a common group. In an optional step, depending on the predetermined WD 120 configuration, the network node 115 may also transmit a control channel message (M/N)PDCCH at a predefined location compared to the WUS (step S220). The network node 115 may then transmit a data message (e.g., PDSCH) at a location defined either in the WD-specific WUS WD-grouping configuration, or in the optional control channel message (step S222).

Some embodiments include one or more of the following:

1. A method in a network node 115 (e.g., eNB), configured with a WD-specific WUS WD-grouping configuration, for paging at least one WD 120, the at least one WD 120 configured with WD-specific WUS WD-grouping, the method comprising:
a. Transmitting information about a WUS WD-group configuration including WD-specific WUS groups;
b. Receiving a paging message from an MME targeting the at least one WD;
c. Determining the paged WD being configured with a WD-specific WUS WD-group based at least in part on the paging message; and
d. Transmitting a sequence corresponding to the WD-specific WUS WD-group of the paged WD.
   2. The method of embodiment 1, wherein the configuration information is provided in SI.
   3. The method of any one of embodiments 1 and 2, wherein the paging message further comprises information on how to transmit a data channel ((N)PDSCH) without first decoding a control channel ((M/N)PDCCH).
   4. The method of any one of embodiments 1-3, wherein the sequence is based at least in part on frequency domain orthogonal cover codes.
   5. The method of any one of embodiments 1-4, wherein such information provides a time and/or frequency offset relative to the PO or WUS location, MCS scheme, etc.
   6. The method of any one of embodiments 1-3, further comprising determining a WUS sequence to transmit according to one or both of:
a. A common WUS WD-group configuration if the at least one WD includes WDs with a non-WD-specific WUS WD-group configuration, and
b. The WD-specific WUS WD-group configuration if only the at least one WD was paged.

Even though the descriptions herein may be explained in the context of one ofa Downlink (DL) and an Uplink (UL) communication, it should be understood that the basic principles disclosed may also be applicable to the other of the one of the DL and the UL communication. In some embodiments in this disclosure, the principles may be considered applicable to a transmitter and a receiver. For DL communication, the network node 115 may be considered to be the transmitter and the receiver is the WD 120. For the UL communication, the transmitter may be considered to be the WD 120 and the receiver is the network node 115.

Although at least some of the description herein may be explained in the context of MTC and NB-IoT channels, such as an NPDSCH, it should be understood that the principles may also be beneficial for other channels.

Any two or more embodiments described in this disclosure may be combined in any way with each other.
Further embodiments are thus also provided:

Embodiment A1. A network node configured to communicate with a wireless device (WD), the network node configured to, and/or comprising a radio interface and/or comprising processing circuitry configured to:

communicate information indicating a wake-up signal (WUS) WD-group configuration including a WD-specific WUS WD-group configuration;

receive at least one paging message for at least one WD;

based at least in part on the at least one paging message, determine the at least one WD being paged, at least one WD of the at least one WD being paged is configured with the WD-specific WUS WD-group configuration; and

communicate a WUS sequence corresponding to a WUS group associated with the at least one WD being paged.

Embodiment A2. The network node of Embodiment A1, wherein the processing circuitry is configured to communicate the information in system information (SI).

Embodiment A3. The network node of Embodiment A1, wherein the processing circuitry is configured to communicate the WUS sequence according to:

a common WUS WD-group configuration, if the at least one WD being paged includes a WD with a non-WD-specific WUS WD-group configuration; and

the WD-specific WUS WD-group configuration, if the at least one WD being paged includes only a WD configured with the WD-specific WUS WD-group configuration.

Embodiment B1. A method implemented in a network node, the method comprising:

communicating information indicating a wake-up signal (WUS) WD-group configuration including a WD-specific WUS WD-group configuration;

receiving at least one paging message for at least one WD;

based at least in part on the at least one paging message, determining the at least one WD being paged, at least one WD of the at least one WD being paged is configured with the WD-specific WUS WD-group configuration; and

communicating a WUS sequence corresponding to a WUS group associated with the at least one WD being paged.

Embodiment B2. The method of Embodiment B1, wherein communicating the information comprises communicating the information indicating the WUS WD-group configuration in system information (SI).

Embodiment B3. The method of Embodiment B1, wherein communicating the WUS sequence comprises communicating the WUS sequence according to:

a common WUS WD-group configuration, if the at least one WD being paged includes a WD with a non-WD-specific WUS WD-group configuration; and

the WD-specific WUS WD-group configuration, if the at least one WD being paged includes only a WD configured with the WD-specific WUS WD-group configuration.

Embodiment C1. A wireless device (WD) configured to communicate with a network node, the WD configured to, and/or comprising a radio interface and/or processing circuitry configured to:

receive information indicating a wake-up signal (WUS) WD-group configuration;

communicate an indication of a WD-specific WUS WD-grouping capability of the WD;

receive a WD-specific WUS WD-group configuration based at least in part on the WD-specific WUS WD-grouping capability of the WD; and

as a result of at least one paging message, receive a WUS sequence corresponding to the WUS WD-group configuration.

Embodiment C2. The WD of Embodiment C1, wherein the processing circuitry is further configured to, based at least in part on information in the WD-specific WUS WD-group configuration, decode a downlink data message from the network node without decoding a corresponding control channel.

Embodiment C3. The WD of Embodiment C1, wherein the processing circuitry is configured to receive the information indicating the WUS WD-group configuration in system information (SI).

Embodiment C4. The WD of Embodiment C1, wherein the WUS sequence is based at least in part on:

a common WUS WD-group configuration, if at least one WD being paged by the at least one paging message includes a WD with a non-WD-specific WUS WD-group configuration; and

the WD-specific WUS WD-group configuration, if the at least one WD being paged includes only a WD configured with the WD-specific WUS WD-group configuration.

Embodiment D1. A method implemented in a wireless device (WD), the method comprising:

receiving information indicating a wake-up signal (WUS) WD-group configuration;

communicating an indication of a WD-specific WUS WD-grouping capability of the WD;

receiving a WD-specific WUS WD-group configuration based at least in part on the WD-specific WUS WD-grouping capability of the WD; and

as a result of at least one paging message, receiving a WUS sequence corresponding to the WUS WD-group configuration.

Embodiment D2. The method of Embodiment D1, further comprising, based at least in part on information in the WD-specific WUS WD-group configuration, decoding a downlink data message from the network node without decoding a corresponding control channel.

Embodiment D3. The method of Embodiment D1, wherein the receiving the information further includes receiving the information indicating the WUS WD-group configuration in system information (SI).

Embodiment D4. The method of Embodiment D1, wherein the WUS sequence is based at least in part on:

a common WUS WD-group configuration, if at least one WD being paged by the at least one paging message includes a WD with a non-WD-specific WUS WD-group configuration; and

the WD-specific WUS WD-group configuration, if the at least one WD being paged includes only a WD configured with the WD-specific WUS WD-group configuration.

Embodiment E1. A network node configured to communicate with a wireless device (WD), the network node configured to, and/or comprising a radio interface and/or comprising processing circuitry configured to:

receive an indication of a WD-specific WUS WD-grouping capability of the WD;

communicate an indication of a WD-specific WUS WD-group configuration based on the WD-specific WUS WD-grouping capability of the WD; and

as a result of data being available for the WD, communicate a paging message for the WD, the paging message identifying the WD-specific WUS WD-group configuration for the WD.

Embodiment E2. The network node of Embodiment E1, wherein the paging message further includes information permitting the WD to decode a downlink data message without decoding a corresponding downlink control channel.

Embodiment F1. A method implemented in a network node, the method comprising:

receiving an indication of a WD-specific WUS WD-grouping capability of the WD;

communicating an indication of a WD-specific WUS WD-group configuration based on the WD-specific WUS WD-grouping capability of the WD; and

as a result of data being available for the WD, communicating a paging message for the WD, the paging message identifying the WD-specific WUS WD-group configuration for the WD.

Embodiment F2. The method of Embodiment F1, wherein the paging message further includes information permitting the WD to decode a downlink data message without decoding a corresponding downlink control channel.

Notably, modifications and other embodiments of the disclosed embodiments will come to mind to one skilled in the art having the benefit of the teachings presented in the foregoing descriptions and the associated drawings. Therefore, it is to be understood that the scope of the disclosure is not to be limited to the specific embodiments disclosed and that modifications and other variants are intended to be included within the scope. Although specific terms can be employed herein, they are used in a generic and descriptive sense only and not for purposes of limitation.

1.-33. (canceled)

34. A method for transmitting a wake-up signal (WUS) to one or more user equipment (UEs) in a cell of a radio access network (RAN), the method comprising:
receiving a paging message identifying at least a portion of the UEs in the cell;
selecting a WUS code associated with the identified UEs, wherein the WUS code is selected from a first plurality of available WUS codes that are mapped to a second plurality of UE groups; and
transmitting the WUS based on the selected WUS code.

35. The method of claim 34, comprising:
determining the mapping between the first plurality of available WUS codes and the second plurality of UE groups; and
transmitting the determined mapping to the one or more UEs.

36. The method of claim 35, wherein determining of the mapping comprises receiving the mapping from another network node in one of the following: the RAN or a core network associated with the RAN.

37. The method of claim 35, wherein determining of the mapping comprises reading configuration information from a storage medium.

38. The method of claim 35, wherein determining of the mapping comprises selecting the number of UE groups comprising the second plurality based on at least one of the following:
a number of available WUS codes,
respective false-alarm rates for the available WUS codes,
paging-rate requirements of the one or more UEs in the cell, and
capabilities of the one or more UEs.

39. The method of claim 38, comprising determining the paging-rate requirements of the one or more UEs based on values of a plurality of paging-related parameters associated with the respective UEs.

40. The method of claim 34, wherein the second plurality is equal to the first plurality.

41. The method of claim 34, wherein the second plurality of UE groups includes at least one of the following:
a plurality of individual UE groups; and
only individual UE groups.

42. The method of claim 41, wherein:
at least one of the first plurality of WUS codes is not associated with a paging opportunity (PO); and
the second plurality of UE groups includes one of the following:
a common UE group associated with all individual UE groups; or
one or more combination UE groups, wherein each combination UE group is associated with a particular combination of multiple individual UE groups.

43. The method of claim 34, comprising receiving, for each of the identified UEs, an identifier of an individual UE group to the particular UE is assigned, wherein selecting the WUS code is based on the identified individual UE groups.

44. The method of claim 43, wherein the identified UEs are associated with a plurality of individual UE groups, and selecting the WUS code comprises selecting an available WUS code corresponding to a combination UE group that includes a minimum number of individual UE groups other than the one or more individual UE groups.

45. The method of claim 34, wherein the available WUS codes include one of the following:
a first plurality of frequency-domain orthogonal cover codes (OCCs) applied over a single time-domain symbol; or
a first plurality of frequency-domain scrambling codes applied over multiple time-domain symbols.

46. A method for receiving a wake-up signal (WUS) transmitted by a network node in a radio access network (RAN), the method comprising:
receiving information comprising a mapping between a first plurality of available WUS codes and a second plurality of UE groups, wherein the second plurality comprises a plurality of individual UE groups and at least one combination UE group associated with multiple individual UE groups;
receiving an assignment to one of the individual UE groups;
receiving a signal during a period when a WUS is expected to be transmitted; and
attempting to detect, in the received signal, a WUS corresponding to any of a third plurality of WUS codes, wherein the third plurality comprises a WUS code associated with the assigned individual UE group and one or more WUS codes associated with respective one or more combination UE groups.

47. The method of claim 46, wherein the at least one combination UE group includes one of the following:
a common UE group associated with all individual UE groups; or
one or more combination UE groups associated with respective subsets of the individual UE groups.

48. The method of claim 46, further comprising, when the WUS corresponding to any of the third plurality of WUS codes is detected, receiving a paging signal during a subsequent paging occasion (PO) at a predefined later time relative to the WUS.

49. The method of claim 46, further comprising, when the WUS corresponding to a particular one of the third plurality of WUS codes is detected, receiving a physical downlink shared channel (PDSCH) at a predefined later time relative to the WUS or to an intervening paging occasion (PO) associated with the WUS, without attempting to receive a paging signal during the PO.

50. The method of claim 46, wherein the available WUS codes include one of the following:
a first plurality of frequency-domain orthogonal cover codes (OCCs) applied over a single time-domain symbol; or
a first plurality of frequency-domain scrambling codes applied over multiple time-domain symbols.

51. A method for paging one or more user equipment (UE) based on wake-up signals (WUS) transmitted in a radio access network (RAN), comprising
assigning each of the one or more UEs to a respective individual UE group;
determining a mapping between a first plurality of available WUS codes and a second plurality of UE groups, wherein the second plurality comprises a plurality of individual UE groups and at least one combination UE group associated with multiple individual UE groups;
sending the determined mapping and the respective individual UE group assignments to the one or more UEs via the RAN;
sending a paging request to a node in the RAN, wherein the paging request identifies at least a portion of the one or more UEs and the respective individual UE group assignments of the identified UEs.

52. A network node configured to transmit a wake-up signal (WUS) to one or more user equipment (UEs) in a radio access network (RAN), the network node comprising:
communication circuitry configured to communicate with the UEs; and
processing circuitry operatively associated with the communication circuitry, whereby the processing circuitry and the communication circuitry are configured to perform operations corresponding to the method of claim 34.

53. A non-transitory, computer-readable medium storing computer-executable instructions that, when executed by processing circuitry of a network node, configure the network node to perform operations corresponding to the method of claim 34.

54. A user equipment (UE) configured to receive a wake-up signal (WUS) transmitted by a network node in a radio access network (RAN), the UE comprising:
communication circuitry configured to communicate with the network node; and
processing circuitry operatively associated with the communication circuitry, whereby the processing circuitry and the communication circuitry are configured to perform operations corresponding to the method of claim 46.

55. A non-transitory, computer-readable medium storing computer-executable instructions that, when executed by processing circuitry of a user equipment (UE), configure the UE to perform operations corresponding to the method of claim 46.

56. A network node configured to page one or more user equipment (UE) based on wake-up signals (WUS) transmitted in a radio access network (RAN), the network node comprising:
communication circuitry configured to communicate with the RAN; and
processing circuitry operatively associated with the communication circuitry and configured to perform operations corresponding to the method of claim 51.

57. A non-transitory, computer-readable medium storing computer-executable instructions that, when executed by processing circuitry of a network node, configure the network node to perform operations corresponding to the method of claim 51.
